(19) United States
(12) Patent Application Publication
(10) Pub. No.: US 2025/0234148 A1
(43) Pub. Date: Jul. 17, 2025

(54) AUDIO PROCESSING METHOD AND DEVICE FOR CLASSIFYING MULTI-CHANNEL AUDIO SIGNAL

(71) Applicant: SAMSUNG ELECTRONICS CO., LTD., Suwon-si (KR)

(72) Inventors: Taeyoung Kim, Suwon-si (KR); Kyungrae Kim, Suwon-si (KR); Jungkyu Kim, Suwon-si (KR); Woohyun Nam, Suwon-si (KR); Sunghee Hwang, Suwon-si (KR); Chanyul Kim, Suwon-si (KR)

(73) Assignee: SAMSUNG ELECTRONICS CO., LTD., Suwon-si (KR)

(21) Appl. No.: 19/031,495

(22) Filed: Jan. 18, 2025

Related U.S. Application Data
(63) Continuation of application No. PCT/KR2025/000597, filed on Jan. 10, 2025.

(30) Foreign Application Priority Data
Jan. 12, 2024 (KR) 10-2024-0005571
Sep. 25, 2024 (KR) 10-2024-0130213

(51) Int. Cl. H04S 5/00

(52) U.S. Cl. CPC H04S 5/005; H04S 2420/01

(57) ABSTRACT

Provided is an electronic device that obtains playback layout information related to audio playback using a plurality of channels, obtains a first audio signal related to an audio to be played back via a low frequency effect (LFE) channel among the plurality of channels, obtains a second audio signal different from the first audio signal, by transforming the first audio signal based on the playback layout information, and transmits the second audio signal to an external device.

### CROSS-REFERENCE TO RELATED APPLICATION(S)

This application is a bypass continuation application of International Application No. PCT/KR2025/000597, filed on Jan. 10, 2025, which is based on and claims priority from Korean Patent Application No. 10-2024-0005571, filed on Jan. 12, 2024, and Korean Patent Application No. 10-2024-0130213, filed on Sep. 25, 2024, the disclosures of which are herein incorporated by reference in their entireties.

### BACKGROUND

### 1. Field

One or more example embodiments of the disclosure relate to an audio processing method and an audio processing device for classifying a multi-channel audio signal. More particularly, the disclosure relates to an audio processing method and a device for classifying an audio signal having a same number of channels but played back via different channel layouts. One or more example embodiments of the disclosure relate to an audio processing method and an audio processing device for pre-processing an input multi-channel audio signal to distinguish between channel layouts from which the audio signal is output. One or more example embodiments of the disclosure relate to an audio processing method and an audio processing device for outputting a multi-channel audio signal pre-processed to distinguish between channel layouts from which the audio signal is output.

### 2. Description of Related Art

In an existing channel layout for a three-dimensional (3D) audio signal, channels are omnidirectionally arranged around a listener. With the expansion of over-the-top (OTT) services, increase in television (TV) resolutions, and enlargement of screens of electronic devices such as tablets, the needs of viewers wanting to experience immersive sound such as theater content in home environments have increased. Therefore, in consideration of sound representation of an object (or sound source) on the screen, it is required to process an audio signal of a 3D audio channel layout in which channels are arranged in front of the listener (e.g., a 3D audio channel layout in front of the listener).

The 3D audio channel layout may configure an audio system including a height channel that provides audio in a vertical direction. For example, among the channel layouts with the same 8 channels, a 5.1.2 channel layout additionally supporting vertical sound and a 7.1.0 channel layout supporting only horizontal sound may be configured.

However, some audio systems may not have a channel layout for playing back audio based on the 5.1.2 channel layout. Also, some audio systems may only receive signals corresponding to the 8 channels, and may receive signals in which 5.1.2 channels and 7.1.0 channels are not distinguished therebetween. Therefore, there is demand for an audio system to distinguish between channel layouts from a received audio signal. In other words, it is required that the audio signal transmitted to the audio system be pre-processed so as to distinguish between the channel layouts.

### SUMMARY

According to an aspect of an example embodiment of the disclosure, an electronic device may include: at least one memory configured to store one or more instructions; and at least one processor configured to execute the one or more instructions to: obtain playback layout information related to a playback of an audio using a plurality of channels; obtain a first audio signal related to an audio to be played back via a low frequency effect (LFE) channel among the plurality of channels; obtain a second audio signal different from the first audio signal, by transforming the first audio signal based on the playback layout information; and transmit the second audio signal to an external device

According to an aspect of an example embodiment of the disclosure, an electronic device may include: at least one memory configured to store one or more instructions; and at least one processor configured to execute the one or more instructions to: receive a low frequency effect (LFE) channel audio signal related to an audio to be played back via an LFE channel among a plurality of channels; determine a channel layout for playing back the audio to be played back via the LFE channel, based on a signal obtained by applying the LFE channel audio signal to one or more band-pass filters; and output an audio according to a signal obtained by applying the LFE channel audio signal to a low-pass filter.

According to an aspect of an example embodiment of the disclosure, a method, performed by an electronic device, of processing an audio signal may include: obtaining playback layout information related to a playback of an audio using a plurality of channels; obtaining a first audio signal related to an audio to be played back via an LFE channel among the plurality of channels; obtaining a second audio signal different from the first audio signal, by transforming the first audio signal based on the playback layout information; and transmitting the second audio signal from the electronic device to an external device.

According to an aspect of an example embodiment of the disclosure, a method, performed by an electronic device, of outputting an audio signal may include: receiving an LFE channel audio signal about an audio to be played back via an LFE channel among a plurality of channels; determining a channel layout for playing back the audio, based on a signal obtained by applying the LFE channel audio signal to one or more band-pass filters; and outputting an audio according to a signal obtained by applying the LFE channel audio signal to a low-pass filter.

According to an aspect of an example embodiment of the disclosure, a non-transitory computer-readable recording medium may store thereon a computer program executable by at least one processor to perform at least one of disclosed embodiments of the methods.

### BRIEF DESCRIPTION OF DRAWINGS

The above and other aspects and features of the disclosure will become more apparent by describing in detail example embodiments thereof with reference to the attached drawings.

FIG. 1 is a conceptual diagram illustrating a system for classifying a multi-channel audio signal, according to an example embodiment of the disclosure.

FIG. 2 is a flowchart for describing an audio processing method for classifying a multi-channel audio signal, according to an example embodiment of the disclosure.

FIG. 3 is a flowchart for describing a method of determining whether to transform an audio signal according to whether a height channel exists, according to an example embodiment of the disclosure.

FIG. 4 is a flowchart for describing a method of determining an audio signal to be transmitted to an external device, according to an example embodiment of the disclosure.

FIG. 5A is a conceptual diagram illustrating an example in which signals are transmitted between respective elements in a method of classifying a multi-channel audio signal, according to an example embodiment of the disclosure.

FIG. 5B is a conceptual diagram illustrating an example in which signals are transmitted between respective elements in a method of classifying a multi-channel audio signal, according to an example embodiment of the disclosure.

FIG. 6A is a graph for describing a first audio signal about audio to be played back via a low frequency effect (LFE) channel, according to an example embodiment of the disclosure.

FIG. 6B is a graph for describing a second audio signal different from a first audio signal, according to an example embodiment of the disclosure.

FIG. 7 is a conceptual diagram for describing a method of playing back audio when an audio system is not provided with a height channel, according to an example embodiment of the disclosure.

FIG. 8 is a conceptual diagram illustrating a system for classifying a multi-channel audio signal, according to an example embodiment of the disclosure.

FIG. 9 is a flowchart for describing a method of classifying a multi-channel audio signal, according to an example embodiment of the disclosure.

FIG. 10 is a flowchart for describing a method of classifying a multi-channel audio signal, according to an example embodiment of the disclosure.

FIG. 11 is a flowchart for describing a method of playing back audio before transformation by filtering an audio signal, according to an example embodiment of the disclosure.

FIG. 12 is a conceptual diagram illustrating a system for classifying a multi-channel audio signal, according to an example embodiment of the disclosure.

FIG. 13 is a flowchart for describing an audio processing method for classifying a multi-channel audio signal, according to an example embodiment of the disclosure.

FIG. 14 is a flowchart for describing a method of classifying a multi-channel audio signal, according to an example embodiment of the disclosure.

FIG. 15A is a graph for describing a first audio signal about audio to be played back via an LFE channel, according to an example embodiment of the disclosure.

FIG. 15B is a graph for describing a second audio signal different from the first audio signal, according to an example embodiment of the disclosure.

FIG. 16 is a flowchart for describing a method of generating a second audio signal by pre-processing a first audio signal, according to an example embodiment of the disclosure.

FIG. 17 is a flowchart for describing a method of restoring a first audio signal before pre-processing, by post-processing a second audio signal, according to an example embodiment of the disclosure.

FIG. 18 is a flowchart for describing a method of interpreting a plurality of audio signals, by post-processing discontinuity between two input audio signals.

FIG. 19 is a diagram for describing a configuration of an audio processing device for processing a multi-channel audio signal, according to an example embodiment of the disclosure.

FIG. 20 is a diagram for describing a configuration of an electronic device for outputting a multi-channel audio signal, according to an example embodiment of the disclosure.

### DETAILED DESCRIPTION

Although the terms used in the disclosure are selected from among common terms that are currently widely used in consideration of their functions in the disclosure, the terms may vary according the intention of one of ordinary skill in the art, a precedent, or the advent of new technology. Also, in particular cases, the terms are discretionally selected by the applicant, and the meaning of those terms will be described in detail in the corresponding part of the detailed description of an embodiment of the disclosure. Therefore, the terms used in the disclosure are not merely designations of the terms, but the terms are defined based on the meaning of the terms and content throughout the disclosure.

As used herein, the singular forms may include the plural forms as well, unless the context clearly indicates otherwise. Unless otherwise defined, all terms including technical or scientific terms used herein may have the same meanings as commonly understood by one of ordinary skill in the art of the disclosure. It will be understood that, although the terms “first”, “second”, etc. used in the present specification may be used herein to describe various elements, these elements should not be limited by these terms. These terms are only used to distinguish one element from another element.

Throughout the specification, when a part “includes” or “comprises” an element, unless there is a particular description contrary thereto, the part may further include other elements, not excluding the other elements. Also, the terms such as “ . . . unit,” “module,” or the like used in the specification indicate a unit, which processes at least one function or operation, and the unit may be implemented by hardware or software, or by a combination of hardware and software.

Hereinafter, the disclosure will now be described more fully with reference to the accompanying drawings for one of ordinary skill in the art to be able to perform an embodiment of the disclosure without difficulty. The disclosure may, however, be embodied in many different forms and should not be construed as being limited to an embodiment of the disclosure set forth herein. In the drawings, parts not related to an embodiment of the disclosure are not illustrated for clarity of explanation, and like reference numerals denote like elements throughout the disclosure.

In the present specification, an “audio processing system” may refer to a system including any device that receives an input of an audio signal and processes the input audio signal and any device that receives and outputs the processed audio signal, and for example, the “audio processing system” may include a “communication module”, an “audio processing device”, and/or an “audio output device”.

In the present specification, an “electronic device” may include an “audio processing device”, an “audio output device”, or an “audio processing system” including the audio processing device and the audio output device.

In the present specification, a “multi-channel audio signal” may refer to an n-channel audio signal (where, n is an integer equal to or greater than 1). A “mono-channel audio signal” may be a one-dimensional (1D) audio signal, a “stereo-channel audio signal” may be a two-dimensional (2D) audio signal, and a “multi-channel audio signal” may include not only the “mono-channel audio signal” and the “stereo-channel audio signal” but also include a three-dimensional (3D) audio signal.

The “3D audio signal” may refer to an audio signal capable of finding the distribution of sound and the position of sound sources in the 3D space.

In the present specification, a “channel (speaker) layout” may refer to a combination of at least one channel and may specify a spatial arrangement of channels (speakers). Here, because the channel is a channel via which an audio signal is actually output, it may be referred to as a presentation channel.

For example, the channel layout may be an X.Y.Z channel layout. Here, X may be the number of surround channels, Y may be the number of subwoofer channels, and Z may be the number of height channels. By the “channel layout”, the spatial position of each of the surround channels/subwoofer channels/height channels may be specified.

Examples of the “channel (speaker) layout” may include a 1.0.0 channel (mono channel) layout, a 2.0.0 channel (stereo channel) layout, a 5.1.0 channel layout, a 5.1.2 channel layout, a 5.1.4 channel layout, a 7.1.0 channel layout, a 7.1.2 channel layout, and a 3.1.2 channel layout, but are not limited thereto and may include various channel layouts.

The names of channels specified by the “channel (speaker) layout” may be various but will be unified for convenience of descriptions.

Based on the spatial positions of the respective channels, the channels of the “channel (speaker) layout” may be named as follows.

For example, the first surround channel of the 1.0.0 channel layout may be named Mono Channel. The first surround channel of the 2.0.0 channel layout may be named L2 Channel, and the second surround channel thereof may be named R2 Channel.

Here, “L” may indicate that it is a channel located on the left side from the viewpoint of the listener, and “R” may indicate that it is a channel located on the right side from the viewpoint of the listener. “2” may indicate that there are a total of two surround channels. “L” may also be referred to as “Front-Left (FL)”, and “R” may also be referred to as “Front-Right (FR)”.

The first surround channel of the 5.1.0 channel layout may be named L5 Channel, the second surround channel thereof may be named R5 Channel, the third surround channel thereof may be named C Channel, the fourth surround channel thereof may be named Ls5 Channel, and the fifth surround channel thereof may be named Rs5 Channel. Here, “C” may indicate a channel located at the center from the viewpoint of the listener. “s” may indicate a channel located at the side. “L5”, “R5”, “Ls5”, and “Rs5” may also be referred to as “L”, “R”, “SL”, and “SR” respectively.

The first subwoofer channel of the 5.1.0 channel layout may be named an LFE Channel. Here, LFE may refer to a low frequency effect. That is, the LFE channel may be a channel for outputting a low frequency effect sound.

The name of the surround channel of each of the 5.1.2 channel layout and the 5.1.4 channel layout and the name of the surround channel of the 5.1.0 channel layout may be the same as each other. Likewise, the name of the subwoofer channel of each of the 5.1.2 channel layout and the 5.1.4 channel layout and the name of the subwoofer channel of the 5.1.0 channel layout may be the same as each other.

The first height channel of the 5.1.2 channel layout may be named HI5. Here, H may refer to a height channel. The second height channel thereof may be named Hr5. “HI5” and “Hr5” may also be referred to as “HFL (High-Front-Left)” and “HFR (High-Front-Right)” respectively.

Moreover, the first height channel of the 5.1.4 channel layout may be named Hfl Channel, the second height channel thereof may be named Hfr Channel, the third height channel thereof may be named Hbl Channel, and the fourth height channel thereof may be named Hbr Channel. Here, “f” may indicate the front channel with respect to the listener, and “b” may indicate the back channel with respect to the listener.

The first surround channel of the 7.1.0 channel layout may be named L Channel, the second surround channel thereof may be named R Channel, the third surround channel thereof may be named C Channel, the fourth surround channel thereof may be named Ls Channel, the fifth surround channel thereof may be named Rs Channel, the sixth surround channel thereof may be named Lb Channel, and the seventh surround channel thereof may be named Rb Channel. “Ls”, “Rs”, “Lb”, and “Rb” may also be referred to as “SL”, “SR”, “BL”, and “BR” respectively.

The name of the surround channel of each of the 7.1.2 channel layout and the 7.1.4 channel layout and the name of the surround channel of the 7.1.0 channel layout may be the same as each other. Likewise, the name of the subwoofer channel of each of the 7.1.2 channel layout and the 7.1.4 channel layout and the name of the subwoofer channel of the 7.1.0 channel layout may be the same as each other.

The first height channel of the 7.1.2 channel layout may be named HI7 Channel, and the second height channel thereof may be named Hr7 Channel. “HI7” and “Hr7” may also be referred to as “HFL” and “HFR” respectively.

The first height channel of the 7.1.4 channel layout may be named Hfl Channel, the second height channel thereof may be named Hfr Channel, the third height channel thereof may be named Hbl Channel, and the fourth height channel thereof may be named Hbr Channel.

The first surround channel of the 3.1.2 channel layout may be named L3 Channel, the second surround channel thereof may be named R3 Channel, and the third surround channel thereof may be named C Channel. The first subwoofer channel of the 3.1.2 channel layout may be named LFE Channel. The first height channel of the 3.1.2 channel layout may be named HI3 Channel, and the second height channel thereof may be named Hr3 Channel.

Here, some channels may be named differently depending on the channel layouts but may represent the same channel. For example, the HI5 channel and the HI7 channel may be the same channel. Likewise, the Hr5 channel and the Hr7 channel may be the same channel.

Moreover, the disclosure is not limited to the above names of the channels and various channel names may be used.

The names of the channels of the channel layouts described above may be summarized as Table 1 below.

TABLE 1

| Channel Layout | Names of Channels |
|---|---|
| 1.0.0 | Mono |
| 2.0.0 | L2/R2 |
| 5.1.0 | L5/C/R5/Ls5/Rs5/LFE |
| 5.1.2 | L5/C/R5/Ls5/Rs5/Hl5/Hr5/LFE |
| 5.1.4 | L5/C/R5/Ls5/Rs5/Hfl/Hfr/Hbl/Hbr/LFE |
| 7.1.0 | L/C/R/Ls/Rs/Lb/Rb/LFE |
| 7.1.2 | L/C/R/Ls/Rs/Lb/Rb/Hl7/Hr7/LFE |
| 7.1.4 | L/C/R/Ls/Rs/Lb/Rb/Hfl/Hfr/Hbl/Hbr/LFE |
| 3.1.2 | L3/C/R3/Hl3/Hr3/LFE |

In the present specification, “upmixing” may refer to an operation in which the number of presentation channels of an output audio signal increases via demixing, compared to the number of presentation channels of an input audio signal.

In the present specification, “demixing” may refer to one of mixing operations as an operation of separating an audio signal of a particular channel from the audio signals in which audio signals of various channels are mixed (i.e., audio signals of a mixed channel). In this case, “demixing” may be implemented by an operation using a “demixing matrix” (or “downmixing matrix” corresponding thereto), and the “demixing matrix” may include at least one “demixing weight parameter” (or “downmixing weight parameter” corresponding thereto) as a coefficient of the demixing matrix (or “downmixing matrix” corresponding thereto). The “demixing weight parameter” may also be referred to as a “demixing parameter”, and the “downmixing weight parameter” may also be referred to as a “downmixing parameter”. Alternatively, “demixing” may be implemented by a mathematical operation based on a portion of a “demixing matrix” (or “downmixing matrix” corresponding thereto), however, the disclosure is not limited thereto and “demixing” may be implemented in various manners. As described above, “demixing” may be related to “upmixing”.

“Mixing” may refer to any operation of generating an audio signal of a new channel (i.e., a mixed channel) by adding the respective values obtained by multiplying audio signals of a plurality of channels by respective corresponding weights (i.e., by mixing audio signals of a plurality of channels).

“Mixing” may be divided into “mixing” in a narrow sense performed by an audio encoding device and “demixing” performed in an audio decoding device.

“Mixing” performed by an audio encoding device may be implemented by an operation using a “(down) mixing matrix”, and the “(down) mixing matrix” may include at least one “(down) mixing weight parameter” as a coefficient of the (down) mixing matrix. Alternatively, “downmixing” may be implemented by a mathematical operation based on a portion of a “downmixing matrix”; however, the disclosure is not limited thereto and “downmixing” may be implemented in various manners.

In the present specification, “downmixing” may refer to an operation in which the number of presentation channels of an output audio signal decreases, compared to the number of presentation channels of an input audio signal input via mixing.

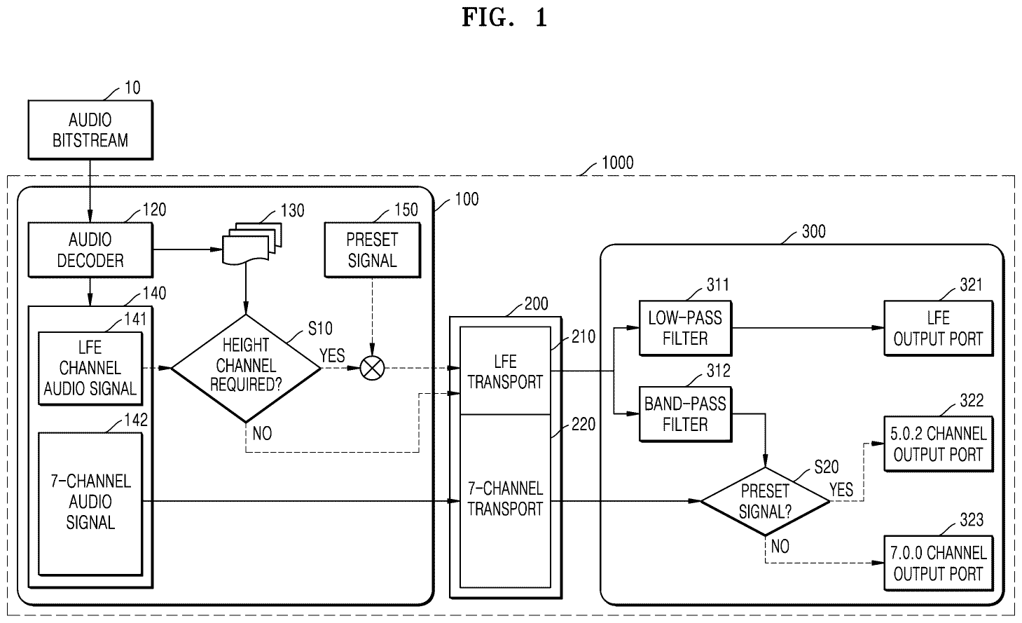

FIG. 1 is a conceptual diagram illustrating a system for classifying a multi-channel audio signal, according to an embodiment of the disclosure.

Referring to FIG. 1, an audio processing system 1000 may include an audio processing device 100, a communication module 200, and an audio output device 300.

The audio processing device 100 may process a multi-channel audio signal. The audio processing device 100 may obtain a multi-channel audio signal and may transform audio signals of some channels among the multi-channel audio signals. The audio processing device 100 may transmit the transformed audio signals to the audio output device 300 via the communication module 200.

### 1. Operation of Audio Processing Device 100

In an embodiment of the disclosure, the audio processing device 100 may include at least one memory and at least one separate processor, and an operation performed by the audio processing device 100 may be performed by the at least one processor. The at least one processor may execute a program or an instruction stored in the at least one memory to cause the audio processing device 100 to perform respective operations. The audio processing device 100 may be implemented as a device capable of audio processing, such as a server, a television (TV), a camera, a mobile phone, a tablet personal computer (PC), a notebook computer, etc.

In an embodiment of the disclosure, the audio processing device 100 may obtain an audio bitstream 10 and playback layout information 130.

The audio bitstream 10 may be an audio signal obtained by encoding a multi-channel audio signal. The audio processing device 100 may obtain the audio bitstream 10 from an external device. For example, the audio processing device 100 may obtain the audio bitstream 10 from a server that provides a streaming service (e.g., an over-the-top (OTT) service).

The playback layout information 130 may include information related to audio playback using a plurality of channels. The playback layout information 130 may include information about an arrangement and a configuration of a plurality of channels for playing back audio.

The playback layout information 130 may be transmitted along with the audio bitstream 10 from the server that provides a streaming service, and the playback layout information 130 may correspond to the audio bitstream 10. The playback layout information 130 may include information about an arrangement and a configuration of a plurality of channels for playing back audio of the audio bitstream 10. For example, when the audio bitstream 10 is to be played back via 5.1.2 channels, the playback layout information 130 may include information specifying a 5.1.2 channel layout.

In an embodiment of the disclosure, the audio processing device 100 may include an audio decoder 120. The audio decoder 120 may receive an input of the audio bitstream 10. The audio decoder 120 may decode the audio bitstream 10 to convert a format of the audio bitstream 10 to be played back as audio. The audio decoder 120 may classify the audio bitstream 10 into audio corresponding to each channel. The audio decoder 120 may restore audio signals of a plurality of channels by using compressed audio signals of independent channels received from the audio bitstream 10.

For example, the audio decoder 120 may decode the audio bitstream 10 into a pulse code modulation (PCM) form. The audio decoder 120 may transmit, to the external device, audio signals of various layouts obtained by decoding the audio bitstream 10.

As illustrated in FIG. 1, the audio decoder 120 may obtain a multi-channel audio signal 140 by decoding the audio bitstream 10. The audio processing device 100 may obtain the multi-channel audio signal 140 by inputting the audio bitstream 10 to the audio decoder 120.

The multi-channel audio signal 140 may include audio signals according to various numbers of channel layouts. With reference to FIG. 1, an 8-channel audio signal is described as an example, but the number of channels is not limited thereto.

The multi-channel audio signal 140 may include an 8-channel audio signal. The multi-channel audio signal 140 may include a low frequency effect (LFE) channel audio signal 141 and a 7-channel audio signal 142. The LFE channel audio signal 141 may be a signal about audio to be played back via the LFE channel among the 8 channels. The 7-channel audio signal 142 may be signals about respective audios to be played back via the other 7 channels other than the LFE channel among the 8 channels.

For reference, each channel audio signal among the 7-channel audio signals 142 may be equally treated and thus will be denoted as one block in FIG. 1.

The 8 channels may include the LFE channel. The 8 channels may further include 7 channels other than the LFE channel. The layout of 7 channels other than the LFE channel may vary and will be simply represented and described as 7 channels, but is not limited thereto. For example, the layout of 7 channels other than the LFE channel may include a 5.0.2 channel layout or may include a 7.0.0 channel layout. In other words, the layout of 7 channels may be a channel layout including 5 surround channels and 2 height channels or may be a channel layout including 7 surround channels.

In an embodiment of the disclosure, the LFE channel audio signal 141 may include an audio signal transmitted to an LFE channel to output a low frequency effect sound. The LFE channel audio signal 141 may include the audio signal corresponding to the LFE channel to output the low frequency effect sound The LFE channel audio signal 141 may include an audio signal of a frequency band which may be played back via a subwoofer speaker.

In an embodiment of the disclosure, the audio processing device 100 may transform the LFE channel audio signal 141, based on the playback layout information 130. The audio processing device 100 may perform an operation of adding a preset signal 150 to the LFE channel audio signal 141. The audio processing device 100 may determine whether to transform the LFE channel audio signal 141 according to the playback layout information 130.

In operation S10, the audio processing device 100 may determine whether a height channel is required for audio playback according to the audio bitstream 10, based on the playback layout information 130. When the height channel is required, the audio processing device 100 may add the preset signal 150 to the LFE channel audio signal 141. When the height channel is not required, the audio processing device 100 may not add the preset signal 150 to the LFE channel audio signal 141.

In an embodiment of the disclosure, the preset signal 150 may include a signal having a high frequency so as to be distinguished from the frequency of the LFE channel. The preset signal 150 may be a signal having a higher frequency of a band than the LFE channel audio signal 141. A frequency domain of the preset signal 150 is not limited, and may be set to be distinguished from the frequency of the LFE channel. For example, the frequency domain of the preset signal 150 and the frequency domain of the LFE channel audio signal 141 may not overlap each other.

The audio processing device 100 may transmit an untransformed LFE channel audio signal or a transformed LFE channel audio signal to the audio output device 300 via the communication module 200 according to the playback layout information 130. The audio output device 300 may determine whether a height channel is required for audio playback according to the audio bitstream 10, based on the received audio signal. The audio output device 300 may play back audio via a suitable channel layout, based on whether the height channel is required.

In the disclosure, a first audio signal may refer to a signal about audio to be played back via the LFE channel. The first audio signal may refer to an untransformed LFE channel audio signal 141, and may refer to an LFE channel audio signal 141 to which the preset signal 150 of FIG. 1 is not added or before the preset signal 150 of FIG. 1 is added.

In the disclosure, a second audio signal may refer to a transformed LFE channel audio signal. The second audio signal may refer to an LFE channel audio signal transformed by adding the preset signal 150 of FIG. 1 to the LFE channel audio signal 141.

For example, the audio processing device 100 may transmit the first audio signal or the second audio signal to the audio output device 300, according to whether the height channel is required. The audio output device 300 may distinguish between the first audio signal and the second audio signal, and thus, may play back audio via an appropriate channel layout.

### 2. Operation of Communication Module 200

In an embodiment of the disclosure, the communication module 200 may include an LFE transport 210 and a 7-channel transport 220. The LFE transport 210 may be configured to transmit a signal about audio to be played back via the LFE channel. The 7-channel transport 220 may be configured to transmit a signal about audio to be played back via 7 channels other than the LFE channel.

The communication module 200 may include, for example, a high-definition multimedia interface (HDMI) that simultaneously transmits digital video and audio signals.

### 3. Operation of Audio Output Device 300

The audio output device 300 may process a transformed multi-channel audio signal, and may output the processed multi-channel audio signal. The audio output device 300 may obtain, via the communication module 200, an untransformed multi-channel audio signal or a multi-channel audio signal transformed by the audio processing device 100. The audio output device 300 may identify, from the untransformed multi-channel audio signal or the transformed multi-channel audio signal, whether a height channel is required and may output audio, based on the required channel layout.

In an embodiment of the disclosure, the audio output device 300 may include at least one memory and at least one separate processor, and an operation performed by the audio output device 300 may be performed by the at least one processor. The processor may execute an instruction or a program stored in the at least one memory to cause the audio output device 300 to perform respective operations.

In an embodiment of the disclosure, the audio output device 300 may include a low-pass filter 311 and a band-pass filter 312. The low-pass filter 311 and the band-pass filter 312 may each refer to a filter that passes a signal between particular frequencies. A frequency band of a signal which passes through the low-pass filter 311 may be different from that of the band-pass filter 312. The low-pass filter 311 may pass a signal of a relatively low frequency band, and the band-pass filter 312 may pass a signal of a relatively high frequency band. For example, frequency bands of signals passing through the low-pass filter 311 and the band-pass filter 312 may not overlap each other.

For example, the low-pass filter 311 may pass a signal of a frequency band less than 400 Hz. For example, the band-pass filter 312 may pass a signal of a frequency band between about 9 kHz and about 15 kHz. However, the frequency band described herein is merely an example, and the disclosure is not limited thereto.

In an embodiment of the disclosure, the audio output device 300 may receive the multi-channel audio signal 140 via the communication module 200.

In detail, the 7-channel audio signal 142 without transformation among the multi-channel audio signals 140 may be obtained by the audio output device 300. As for the LFE channel audio signal 141 among the multi-channel audio signals 140, according to a preset condition, a transformed LFE channel audio signal may be obtained by the audio output device 300 or an untransformed LFE channel audio signal may be obtained by the audio output device 300. When the audio playback via the height channel is required based on the playback layout information 130, a transformed LFE channel audio signal may be obtained by the audio output device 300. When the audio playback via the height channel is not required based on the playback layout information 130, an untransformed LFE channel audio signal may be obtained by the audio output device 300.

### 3.1. Application of Low-Pass Filter 311 in Audio Output Device 300

In an embodiment of the disclosure, the audio output device 300 may filter, via the low-pass filter 311, the LFE channel audio signal transformed by the audio processing device 100 or the LFE channel audio signal not transformed by the audio processing device 100.

The transformed LFE channel audio signal may be an audio signal to which the preset signal 150 is added. The preset signal 150 may be blocked by the low-pass filter 311, and the audio output device 300 may restore the LFE channel audio signal 141 to the condition before being transformed, by applying the transformed LFE channel audio signal to the low-pass filter 311.

The untransformed LFE channel audio signal may refer to an LFE channel audio signal 141 decoded by the audio decoder 120. The audio output device 300 may obtain the LFE channel audio signal 141 via the communication module 200.

The untransformed LFE channel audio signal may be an audio signal to which the preset signal 150 is not added. The audio output device 300 may obtain the LFE channel audio signal 141 by applying the untransformed LFE channel audio signal to the low-pass filter 311. As the LFE channel audio signal 141 is passed by the low-pass filter 311, the untransformed LFE channel audio signal before being filtered by the low-pass filter 311 and the untransformed LFE channel audio signal after being filtered by the low-pass filter 311 may be equal to each other.

The audio output device 300 may consistently obtain the LFE channel audio signal 141 by applying the transformed LFE channel audio signal or the untransformed LFE channel audio signal to the low-pass filter 311. When the LFE channel audio signal 141 with the preset signal 150 added thereto has been transmitted to the audio output device 300, the audio output device 300 may selectively remove the preset signal 150 via the low-pass filter 311.

The audio output device 300 may output audio according to the LFE channel audio signal 141 via an LFE output port 321. The LFE channel audio signal 141 may be output via the LFE channel. The audio output device 300 may output audio according to a signal obtained by applying the LFE channel audio signal 141 to the low-pass filter 311.

### 3.2. Application of Band-Pass Filter 312 in Audio Output Device 300

In an embodiment of the disclosure, the audio output device 300 may filter, via the band-pass filter 312, the LFE channel audio signal transformed by the audio processing device 100 or the LFE channel audio signal not transformed by the audio processing device 100.

In operation S20, the audio output device 300 according to an embodiment of the disclosure may determine whether the preset signal 150 has been added, based on the LFE channel audio signal filtered by the band-pass filter 312.

The transformed LFE channel audio signal may be an audio signal to which the preset signal 150 is added. The transformed LFE channel audio signal may be a combination of the LFE channel audio signal 141 and the preset signal 150. The preset signal 150 may be passed by the band-pass filter 312. The LFE channel audio signal 141 may be blocked by the band-pass filter 312. The audio output device 300 may identify that the preset signal 150 has been added, by passing the transformed LFE channel audio signal via the band-pass filter 312.

In an embodiment of the disclosure, the audio output device 300 may determine whether the LFE channel audio signal filtered by the band-pass filter 312 exceeds a threshold. The audio output device 300 may obtain a frequency-intensity graph of the LFE channel audio signal filtered by the band-pass filter 312. It may be determined whether an intensity exceeding a threshold is detected corresponding to a preset frequency domain in the obtained graph. When the intensity exceeding the threshold is detected corresponding to a preset frequency domain, the audio output device 300 may determine that the preset signal 150 has been added to the LFE channel audio signal 141.

When the preset signal 150 has been added to the LFE channel audio signal, the audio output device 300 may determine that the audio playback via the height channel is required. The audio output device 300 may output audio according to the 7-channel audio signal 142 via a 5.0.2 channel output port 322. The 7-channel audio signal 142 may be output via the 5.0.2 channel layout. The 5.0.2 channel layout may be a channel layout including two height channels.

The untransformed LFE channel audio signal may be an audio signal to which the preset signal 150 is not added. The LFE channel audio signal 141 may be blocked by the band-pass filter 312. The audio output device 300 may identify that the preset signal 150 has not been added, by passing the untransformed LFE channel audio signal via the band-pass filter 312.

When the preset signal 150 has not been added to the LFE channel audio signal, the audio output device 300 may determine that the audio playback via the height channel is not required. The audio output device 300 may output audio according to the 7-channel audio signal 142 via a 7.0.0 channel output port 323. The 7-channel audio signal 142 may be output via the 7.0.0 channel layout. The 7.0.0 channel layout may be a channel layout not including a height channel.

With reference to FIG. 1, as the 8-channel audio signal is provided as an example, it is described that the 7-channel audio signal 142 is output in the 5.0.2 channel layout or the 7.0.0 channel layout. However, the disclosure is not limited and a method according to an embodiment of the disclosure may be used to distinguish between the 5.1.0 channel layout and the 3.1.2 channel layout and may be used to distinguish between the 9.1.0 channel layout, the 7.1.2 channel layout, and the 5.1.4 channel layout. The disclosure is not limited to the above examples.

In an embodiment of the disclosure, the audio processing device 100 configured to process the multi-channel audio signal and the audio output device 300 configured to output the multi-channel audio signal are separately described, but a portion or all of the operations performed by each device may be performed by the audio processing device 100 or may be performed by the audio output device 300.

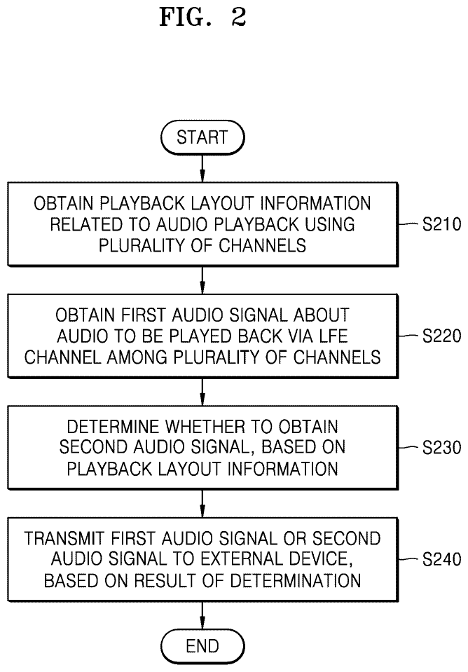

FIG. 2 is a flowchart for describing an audio processing method for classifying a multi-channel audio signal, according to an embodiment of the disclosure.

Referring to FIG. 2, in operation S210, an electronic device may obtain playback layout information related to audio playback using a plurality of channels.

In an embodiment of the disclosure, the electronic device may obtain a bitstream and playback layout information. For example, the electronic device may obtain an audio bitstream and playback layout information from a server that provides a streaming service (e.g., an OTT service).

The bitstream may include a compressed audio signal about audio played back by using a plurality of channels. The electronic device may receive an input of the bitstream and may restore audio to be played back via a plurality of channels. The electronic device may obtain a multi-channel audio signal from the bitstream.

The playback layout information may include information about a channel layout for playing back audio according to the obtained bitstream. For example, the electronic device may obtain a multi-channel audio signal capable of being played back via the 8-channel layout from the bitstream, and the playback layout information may include information specifying to play back the obtained multi-channel audio signal in the 5.1.2 channel layout among the 8-channel layouts.

In operation S220, the electronic device may obtain a first audio signal about audio to be played back via the LFE channel among the plurality of channels.

In an embodiment of the disclosure, the electronic device may obtain a multi-channel audio signal from the bitstream. The multi-channel audio signal may include a plurality of audio signals capable of being played back via the plurality of channels. The electronic device may obtain a first audio signal about audio to be played back via the LFE channel.

The first audio signal may include an audio signal capable of being played back by the LFE channel that outputs a low frequency effect sound.

In operation S230, the electronic device may determine whether to obtain a second audio signal, based on the playback layout information.

In an embodiment of the disclosure, the electronic device may determine whether to transform the first audio signal, based on the playback layout information. The electronic device may determine a channel layout in which the first audio signal is to be played back, based on the playback layout information. The electronic device may determine whether to obtain the second audio signal, according to the determined channel layout.

For example, when the electronic device determines, based on the playback layout information, that audio has to be played back via a channel layout including a height channel, the electronic device may obtain the second audio signal. When the electronic device determines, based on the playback layout information, that audio is not to be played back via the channel layout including the height channel, the electronic device may maintain the first audio signal.

In an embodiment of the disclosure, the second audio signal may be a signal transformed from the first audio signal. The second audio signal may be a signal different from the first audio signal. When the electronic device determines to obtain the second audio signal, the electronic device may obtain the second audio signal by transforming the first audio signal.

For example, the electronic device may obtain the second audio signal by adding a preset signal to the first audio signal. As another example, the electronic device may obtain the second audio signal by modulating the first audio signal with a carrier signal. However, a method of transforming the first audio signal to obtain the second audio signal is merely an example and is not limited.

In operation S240, the electronic device may transmit the first audio signal or the second audio signal to an external device, based on a result of the determination at operation S230.

In an embodiment of the disclosure, the electronic device may maintain the first audio signal or obtain the second audio signal, based on the result of the determination. The electronic device may transmit the first audio signal or the second audio signal to the external device, based on the result of the determination.

For example, when the electronic device determines, based on the playback layout information, that audio has to be played back via a channel layout including a height channel, the electronic device may transmit the second audio signal to the external device. When the electronic device determines, based on the playback layout information, that audio is not to be played back via the channel layout including the height channel, the electronic device may transmit the first audio signal to the external device.

In an embodiment of the disclosure, the electronic device may transmit the first audio signal or the second audio signal to the external device via a communication device. For example, the electronic device may transmit the first audio signal or the second audio signal to an audio output device via an HDMI.

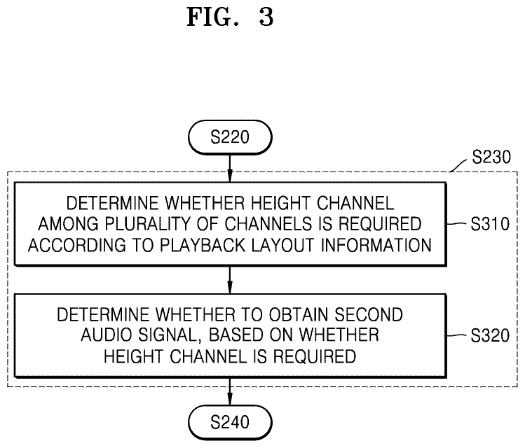

FIG. 3 is a flowchart for describing a method of determining whether to transform an audio signal according to whether a height channel exists, according to an embodiment of the disclosure.

For convenience of descriptions, redundant descriptions with those provided with reference to FIGS. 1-2 will be simplified or omitted.

Referring to FIG. 3, operation S230 of FIG. 2 may include operations S310 and S320.

In operation S310, the electronic device may determine whether a height channel among the plurality of channels is required according to the playback layout information. For example, the electronic device may obtain a multi-channel audio signal capable of being played back via the 8-channel layout from the bitstream, and the playback layout information may include information specifying to play back the multi-channel audio signal via the 5.1.2 channel layout among the 8 channel layouts.

In operation S320, the electronic device may determine whether to obtain the second audio signal, based on whether the height channel is required.

In an embodiment of the disclosure, the electronic device may determine, based on the playback layout information, whether the multi-channel audio signal corresponding to the bitstream is required to be played back according to a channel layout including the height channel.

When the multi-channel audio signal is required to be played back according to the channel layout including the height channel, the electronic device may transform the first audio signal. The electronic device may obtain the second audio signal transformed from the first audio signal.

When the multi-channel audio signal is required to be played back according to a channel layout not including the height channel, the electronic device may not transform the first audio signal.

Operation S240 may be performed after operation S320 is performed. When the electronic device transforms the first audio signal to obtain the second audio signal, the electronic device may transmit the second audio signal to the external device. When the electronic device does not transform the first audio signal, the electronic device may transmit the first audio signal to the external device.

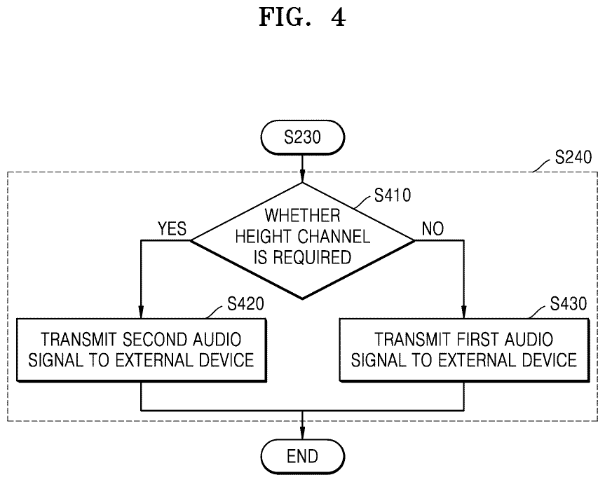

FIG. 4 is a flowchart for describing a method of determining an audio signal to be transmitted to an external device, according to an embodiment of the disclosure.

For convenience of descriptions, redundant descriptions with those provided with reference to FIGS. 2 and 3 will be simplified or omitted.

Referring to FIG. 4, operation S240 of FIG. 2 may include operations S410 to S430.

In operation S410, the electronic device may determine whether the height channel is required, according to the playback layout information.

In an embodiment of the disclosure, the playback layout information may include information about a channel layout for playing back the multi-channel audio signal corresponding to the bitstream. For example, the playback layout information may include information specifying that the multi-channel audio signal is to be played back according to the 5.1.2 channel layout.

The electronic device may determine, according to the playback layout information, whether the channel layout for playing back the multi-channel audio signal corresponding to the bitstream includes a height channel. The electronic device may determine whether a specified channel layout requires a height channel according to the playback layout information.

In operation S420, the electronic device may transmit the second audio signal to the external device when the height channel is required.

In an embodiment of the disclosure, the electronic device may transform the first audio signal when the height channel is required. The electronic device may obtain the second audio signal by transforming the first audio signal. The electronic device may transmit the second audio signal to the external device. For example, the electronic device may transmit the second audio signal to an audio output device.

A method of transforming the first audio signal is not limited. For example, the first audio signal may be transformed by adding a preset signal thereto, or may be transformed by performing a modulation operation, based on a carrier signal.

In operation S430, the electronic device may transmit the first audio signal to the external device when the height channel is not required.

In an embodiment of the disclosure, the electronic device may not transform the first audio signal when the height channel is not required. The electronic device may transmit the first audio signal to the external device. For example, the electronic device may transmit the first audio signal to an audio output device.

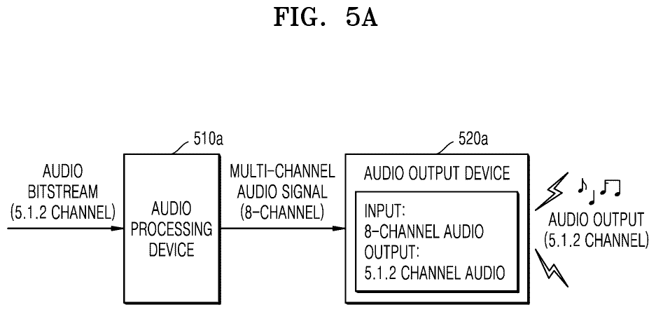

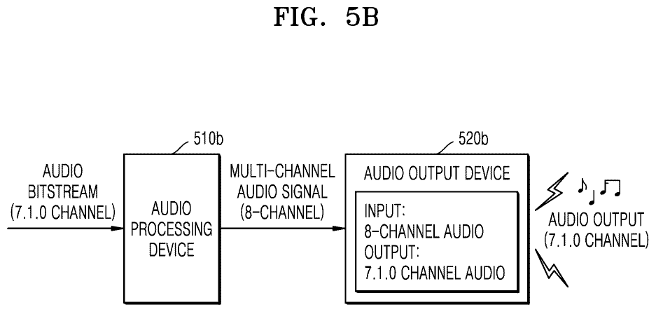

FIG. 5A is a conceptual diagram illustrating an example in which signals are transmitted between respective elements in a method of classifying a multi-channel audio signal, according to an embodiment of the disclosure.

For convenience of descriptions, redundant descriptions with those provided with reference to FIGS. 1 to 4 will be simplified or omitted.

Referring to FIG. 5A, a system according to an embodiment of the disclosure may obtain an audio bitstream (e.g., 5.1.2 channel). The audio bitstream may be an audio signal transmitted by encoding an audio signal.

In an embodiment of the disclosure, an audio processing device 510a may obtain an audio bitstream from an external device. For example, the audio processing device 510a may obtain an audio bitstream from a server that provides a streaming service (e.g., an OTT service).

The audio bitstream may be an audio signal that is required to be played back by a specified channel layout. For example, the audio bitstream may be obtained along with playback layout information (see 130 of FIG. 1), and the playback layout information may include information about a channel layout for playing back the audio bitstream.

Examples of the channel layout for playing back the audio bitstream may include 6-channel layouts (e.g., 3.1.2 channel layout and 5.1.0 channel layout), 8-channel layouts (e.g., 5.1.2 channel layout and 7.1.0 channel layout), and 10-channel layouts (e.g., 5.1.4 channel layout, 7.1.2 channel layout, and 9.1.0 channel layout), but the disclosure is not limited thereto and various channel layouts may be used.

As an example, FIG. 5A illustrates an audio bitstream (5.1.2 channel) played back via the 5.1.2 channel layout.

In an embodiment of the disclosure, the audio processing device 510a may obtain a multi-channel audio signal (e.g., 8 channel) by receiving an input of an audio bitstream (5.1.2 channel). The audio processing device 510a may restore audio signals of a plurality of channels by using compressed audio signals of independent channels received from the audio bitstream (5.1.2 channel).

In an embodiment of the disclosure, the audio processing device 510a may obtain a multi-channel audio signal (8 channel) by transforming the restored audio signals. The audio processing device 510a may determine whether to transform the restored audio signals, based on information about a channel layout for playing back the audio bitstream (5.1.2 channel).

For example, the audio processing device 510a may determine whether a height channel is required, based on information about a channel layout for playing back the audio bitstream (5.1.2 channel). As illustrated in FIG. 5A, when the audio bitstream (5.1.2 channel) is to be played back according to the 5.1.2 channel layout, the height channel is required.

In an embodiment of the disclosure, the audio processing device 510a may transform the restored audio signal when the height channel is required in the channel layout for playing back the audio bitstream (5.1.2 channel). The audio processing device 510a may obtain a multi-channel audio signal (8 channel) by transforming the restored audio signal.

For example, the audio processing device 510a may add a preset signal to the restored audio signal. The restored audio signal may be an audio signal of a plurality of channels, and the audio processing device 510a may add a preset signal to an audio signal of the LFE channel among the restored audio signals. The preset signal may include a signal having a high frequency and may be a signal having a frequency domain that is distinguished from an audio signal of the LFE channel that outputs a low frequency effect sound.

As another example, the audio processing device 510a may perform a modulation operation on the restored audio signal by using a carrier signal. The restored audio signal may be an audio signal of a plurality of channels, and the audio processing device 510a may perform a modulation operation on an audio signal of the LFE channel among the restored audio signals by using a carrier signal. For example, the modulation operation may include an operation of multiplying the audio signal by the carrier signal, and the frequency of the audio signal may be transformed via the modulation operation.

In an embodiment of the disclosure, the audio output device 520a may obtain a multi-channel audio signal (8 channel). By adding the preset signal or performing the modulation operation, the multi-channel audio signal (8 channel) may include information indicating that the audio signal has been transformed. By adding the preset signal or performing the modulation operation, the multi-channel audio signal (8 channel) may include information indicating that the height channel is required in the channel layout for playing back the audio bitstream.

In an embodiment of the disclosure, by analyzing the multi-channel audio signal (8 channel), the audio output device 520a may obtain information indicating that the height channel is required in the channel layout for playing back the audio bitstream (5.1.2 channel). Based on the multi-channel audio signal (8 channel), the audio output device 520a may output an audio (5.1.2 channel) according to a channel layout including the height channel.

FIG. 5B is a conceptual diagram illustrating an example in which signals are transmitted between respective elements in a method of classifying a multi-channel audio signal, according to an embodiment of the disclosure.

For convenience of descriptions, differences from the description provided with reference to FIGS. 1-5A will be mainly described. For reference, as an example, FIG. 5B illustrates a case where an audio bitstream (7.1.0 channel) to be played back via the 7.1.0 channel layout is obtained.

Referring to FIG. 5B, a system according to an embodiment of the disclosure may obtain an audio bitstream (7.1.0 channel). The audio bitstream may be an audio signal transmitted by encoding an audio signal.

In an embodiment of the disclosure, an audio processing device 510b may obtain a multi-channel audio signal (8 channel) by receiving an input of an audio bitstream (7.1.0 channel). The audio processing device 510b may restore audio signals of a plurality of channels by using compressed audio signals of independent channels received from the audio bitstream (7.1.0 channel).

In an embodiment of the disclosure, the audio processing device 510b may obtain a multi-channel audio signal (8 channel) by transforming the restored audio signals. The audio processing device 510b may determine whether to transform the restored audio signals, based on information about a channel layout for playing back the audio bitstream (7.1.0 channel).

For example, the audio processing device 510b may determine whether a height channel is required, based on information about a channel layout for playing back the audio bitstream (7.1.0 channel). As illustrated in FIG. 5B, when the audio bitstream (7.1.0 channel) is to be played back according to the 7.1.0 channel layout, the height channel is not required.

In an embodiment of the disclosure, when the height channel is not required in the channel layout for playing back the audio bitstream (7.1.0 channel), the audio processing device 510b may transmit the restored audio signal as a multi-channel audio signal (8 channel) to an audio output device 520b. When the height channel is not required, the audio processing device 510b may use the audio signal restored from the audio bitstream as a multi-channel audio signal (8 channel) without transformation.

In an embodiment of the disclosure, the audio output device 520b may obtain a multi-channel audio signal (8 channel). The multi-channel audio signal (8 channel) may be an untransformed signal, and the untransformed multi-channel audio signal (8 channel) may include information indicating that the height channel is not required in the channel layout for playing back the audio bitstream (7.1.0 channel).

In an embodiment of the disclosure, by analyzing the multi-channel audio signal (8 channel), the audio output device 520b may obtain information indicating that the height channel is not required in the channel layout for playing back the audio bitstream (7.1.0 channel). Based on the multi-channel audio signal (8 channel), the audio output device 520b may output audio (7.1.0 channel) according to a channel layout not including the height channel.

An audio output device of the related art may obtain a multi-channel audio signal but may only receive, for example, an 8-channel audio signal and may fail to obtain information about in which channel layout the 8 channels are configured. Referring to FIGS. 5A and 5B, by transforming the audio signal, the system according to an embodiment of the disclosure may transmit, to an audio output device, a multi-channel audio signal (8 channel) including information about whether the height channel is required. Thus, the audio output device may identify whether the height channel is required and, accordingly, may determine an appropriate channel layout to output audio (5.1.2 channel or 7.1.0 channel).

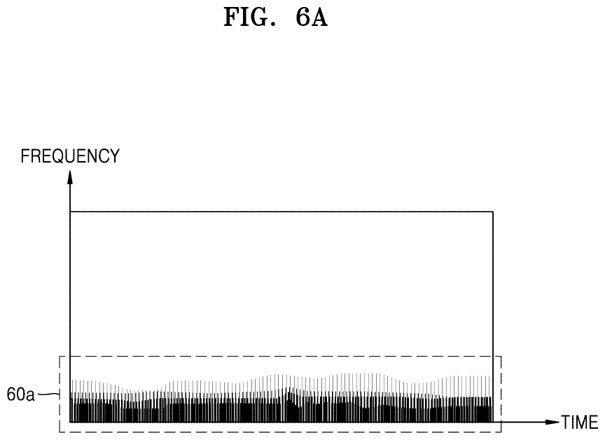

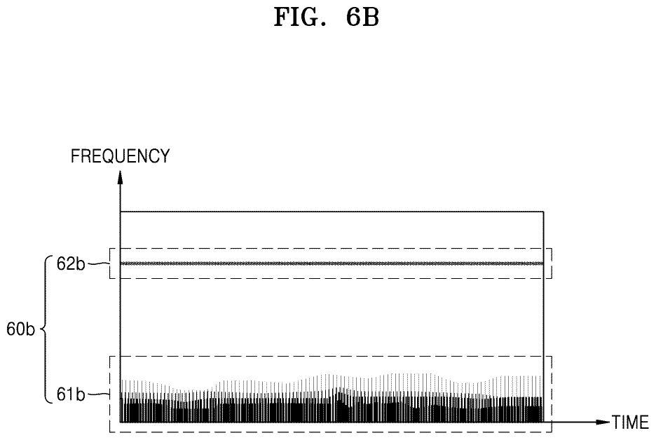

FIG. 6A is a graph for describing a first audio signal about audio to be played back via an LFE channel, according to an embodiment of the disclosure. FIG. 6B is a graph for describing a second audio signal transformed from the first audio signal, according to an embodiment of the disclosure.

For reference, FIGS. 6A and 6B are each a frequency-time graph of an LFE channel audio signal of the multi-channel audio signal transmitted from an audio processing device to an audio output device according to an embodiment of the disclosure. In detail, FIG. 6A is the graph of an untransformed LFE channel audio signal, and FIG. 6B is the graph of an LFE channel audio signal transformed by adding a preset signal thereto.

Referring to FIG. 6A, the graph of an untransformed LFE channel audio signal 60a is illustrated. The LFE channel audio signal 60a may be an audio signal capable of being played back via a channel for outputting a low frequency effect sound. The LFE channel audio signal 60a may be generated in a low frequency domain. The LFE channel audio signal 60a may include an audio signal having a low frequency band. For example, the LFE channel audio signal 60a may include an audio signal of a frequency band less than 400 Hz.

Referring to FIG. 6B, the graph of a transformed LFE channel audio signal 60b obtained by adding a preset signal thereto is illustrated. The transformed LFE channel audio signal 60b may include an original LFE channel audio signal 61b and a preset signal 62b. The transformed LFE channel audio signal 60b may be a combination of the original LFE channel audio signal 61b and the preset signal 62b.

In an embodiment of the disclosure, the original LFE channel audio signal 61b may refer to an LFE channel audio signal before the preset signal 62b is added and may be equal to the untransformed LFE channel audio signal 60a of FIG. 6A.

In an embodiment of the disclosure, the preset signal 62b may be a signal having a frequency domain that is distinguished from the original LFE channel audio signal 61b. The preset signal 62b may be a signal having a high frequency band that is distinguished from the low frequency band of the LFE channel. For example, the frequency domain of the preset signal 62b may not overlap the frequency domain of the LFE channel.

In an embodiment of the disclosure, when the electronic device determines that a height channel is required to play back audio including an LFE channel audio signal, the electronic device may transmit, to an external device, the transformed LFE channel audio signal 60b to which the preset signal 62b is added. When the electronic device determines that a height channel is not required to play back audio including an LFE channel audio signal, the electronic device may transmit, to the external device, the untransformed LFE channel audio signal 60a of FIG. 6A.

Referring to FIG. 1 along with FIGS. 6A and 6B, in an embodiment of the disclosure, when the LFE channel audio signal 141 is transformed according to the determination in operation S10, the audio output device 300 may receive the LFE channel audio signal to which the preset signal 150 is added. The received LFE channel audio signal is the transformed LFE channel audio signal 60b illustrated in the graph of FIG. 6B.

The audio output device 300 may apply the transformed LFE channel audio signal 60b to the low-pass filter 311. As the audio output device 300 filters the transformed LFE channel audio signal 60b by using the low-pass filter 311, the audio output device 300 may obtain only the original LFE channel audio signal 61b having a low frequency domain. The audio output device 300 may output the original LFE channel audio signal 61b via the LFE output port 321.

The audio output device 300 may apply the transformed LFE channel audio signal 60b to the band-pass filter 312. As the audio output device 300 filters the transformed LFE channel audio signal 60b by using the band-pass filter 312, the audio output device 300 may determine whether the preset signal (e.g., 150 or 62b) having a preset frequency domain has been added. Referring to the graph of FIG. 6B, as the preset signal 62b having a preset frequency domain is included in the transformed LFE channel audio signal 60b, the audio output device 300 may identify that the preset signal 62b has been added. When the preset signal 62b has been added, the audio output device 300 may output the 7-channel audio signal 142 via the 5.0.2 channel output port 322. In other words, the audio output device 300 may determine that the audio has to be played back via the 5.0.2 channel layout including the height channel, and may output the 7-channel audio signal 142 via the 5.0.2 channel layout.

In an embodiment of the disclosure, when the LFE channel audio signal 141 is not transformed according to the determination in operation S10, the audio output device 300 may receive the untransformed LFE channel audio signal. The received LFE channel audio signal is the untransformed LFE channel audio signal 60a illustrated in the graph of FIG. 6A.

The audio output device 300 may apply the untransformed LFE channel audio signal 60a to the low-pass filter 311. As the untransformed LFE channel audio signal 60a includes only a signal having a low frequency domain, the audio output device 300 may changelessly obtain the untransformed LFE channel audio signal 60a. The audio output device 300 may output the untransformed LFE channel audio signal 60a via the LFE output port 321.

The audio output device 300 may apply the untransformed LFE channel audio signal 60a to the band-pass filter 312. As the audio output device 300 filters the untransformed LFE channel audio signal 60a by using the band-pass filter 312, the audio output device 300 may determine whether the preset signal 150 having a preset frequency domain has been added. Referring to the graph of FIG. 6A, as the untransformed LFE channel audio signal 60a includes only a signal of a low frequency domain, the audio output device 300 may identify that the preset signal 150 has not been added. When the preset signal 150 has not been added, the audio output device 300 may output the 7-channel audio signal 142 via the 7.0.0 channel output port 323. In other words, the audio output device 300 may determine that the audio has to be played back via the 7.0.0 channel layout not including the height channel, and may output the audio via the 7.0.0 channel layout.

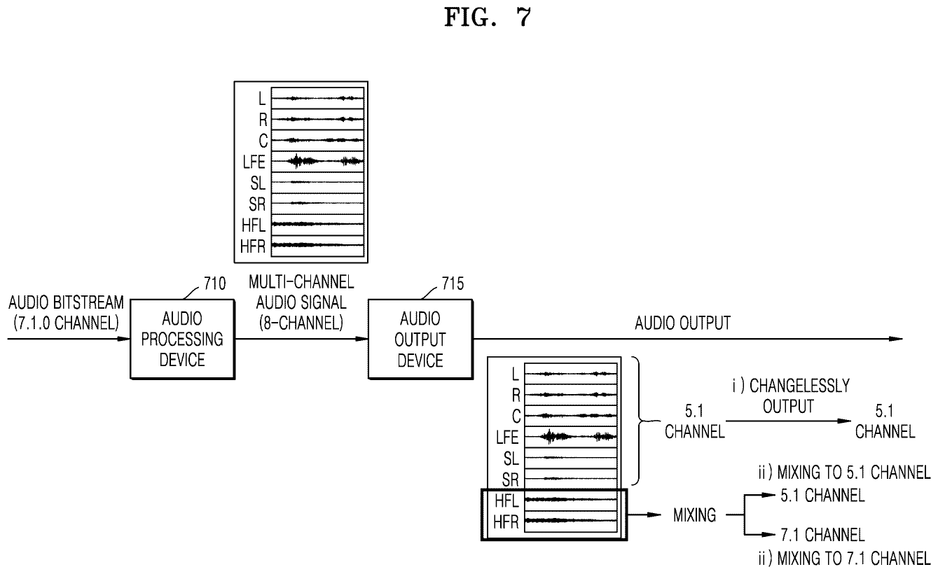

FIG. 7 is a conceptual diagram for describing a method of playing back audio when an audio system is not provided with a height channel, according to an embodiment of the disclosure.

For convenience of descriptions, redundant descriptions with those provided with reference to FIGS. 1-6 will be simplified or omitted.

Referring to FIG. 7, an audio processing device 710 may obtain a multi-channel audio signal (8 channel) by receiving an input of an audio bitstream (7.1.0 channel). The multi-channel audio signal (8 channel) may be a signal corresponding to a 5.1.2 channel layout including five surround channels (L, R, C, SL, SR), one LFE channel, and two height channels (HFL, HFR).

In an embodiment of the disclosure, an audio output device 715 may obtain a multi-channel audio signal (8 channel). A preset signal may be added to or a modulation operation may be performed on the multi-channel audio signal (8 channel), such that an audio signal may be transformed. The preset signal may be added to the LFE channel audio signal of the multi-channel audio signal (8 channel), such that the audio signal may be transformed. That the multi-channel audio signal (8 channel) has been transformed may correspond to information indicating the height channel is required in a channel layout for playing back the audio bitstream.

In an embodiment of the disclosure, by analyzing the multi-channel audio signal (8 channel), the audio output device 715 may obtain information indicating that the height channel is required in the channel layout for playing back the audio bitstream (5.1.2 channel).

In an embodiment of the disclosure, the audio output device 715 may not include the height channel. Even when the audio output device 715 obtains information indicating that the height channel is required, the audio output device 715 may fail to play back the audio via a channel layout including the height channel. The audio output device 715 may distribute the audio such that the audio bitstream (5.1.2 channel) may be played back via a channel layout excluding the height channel.

In an embodiment of the disclosure, the audio output device 715 may output, via 6 channels, audio according to the multi-channel audio signal (8 channel) including the height channel.

For example, the audio output device 715 may obtain the multi-channel audio signal (8 channel). The audio output device 715 may output, via a 5.1.0 channel output port, audio according to the 6-channel audio signal (L, R, C, LFE, SL, SR) excluding the height channel (HFL, HFR). The audio output device 715 may not output audio according to an audio signal played back via the height channel (HFL, HFR).

As another example, the audio output device 715 may obtain the multi-channel audio signal (8 channel). The audio output device 715 may mix audio signals played back via the height channels (HFL, HFR). The audio output device 715 may convert the audio signal into a 6-channel (5.1.0 channel) audio signal by mixing 8-channel audio signals. The audio output device 715 may output the mixed 6-channel audio signal via the 5.1.0 channel output port.

In an embodiment of the disclosure, the audio output device 715 may output, via 8 channels not including the height channel, audio according to the multi-channel audio signal (8 channel) including the height channel. The audio output device 715 may output, via the 7.1.0 channel layout, audio according to the multi-channel audio signal played back in the 5.1.2 channel layout.

For example, the audio output device 715 may obtain the multi-channel audio signal (8 channel). The audio output device 715 may mix audio signals played back via the height channels (HFL, HFR). The audio output device 715 may convert the audio signal into an 8-channel (7.1.0 channel) audio signal by mixing 8-channel audio signals. The audio output device 715 may output the mixed 8-channel audio signal via a 7.1.0 channel output port.

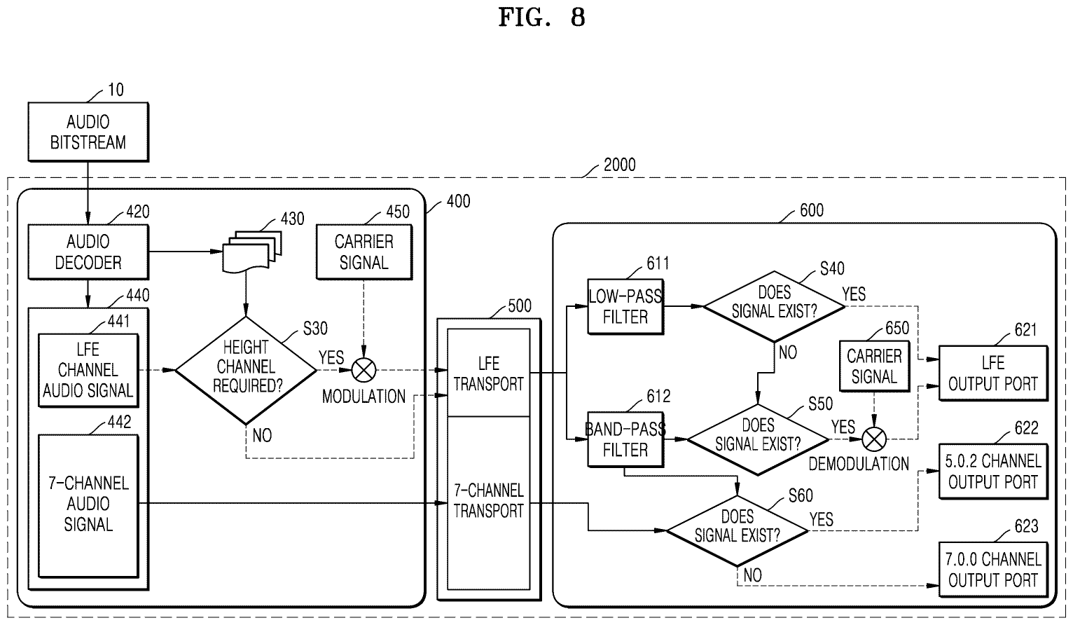

FIG. 8 is a conceptual diagram illustrating a system for classifying a multi-channel audio signal, according to an embodiment of the disclosure.

For convenience of descriptions, differences from the description provided with reference to FIG. 1 will be mainly described.

Referring to FIG. 8, an audio processing system 2000 may include an audio processing device 400, a communication module 500, and an audio output device 600.

The audio processing device 400 may process a multi-channel audio signal. The audio processing device 400 may obtain a multi-channel audio signal, and may transform audio signals of some channels of the multi-channel audio signal. The audio processing device 400 may transmit the transformed audio signals to the audio output device 600 via the communication module 500.

### 1. Operation of Audio Processing Device 400

In an embodiment of the disclosure, the audio processing device 400 may transform an LFE channel audio signal 441 based on playback layout information 430. The audio processing device 400 may perform a modulation operation on the LFE channel audio signal 441 by using a carrier signal 450. The audio processing device 400 may determine whether to transform the LFE channel audio signal 441 according to the playback layout information 430.

In operation S30, the audio processing device 400 may determine whether a height channel is required for audio playback according to the audio bitstream 10, based on the playback layout information 430. When the height channel is required, the audio processing device 400 may perform a modulation operation on the LFE channel audio signal 441, based on the carrier signal 450. When the height channel is not required, the audio processing device 400 may not perform the modulation operation on the LFE channel audio signal 441, based on the carrier signal 450.

The audio processing device 400 may transmit an untransformed LFE channel audio signal or a transformed LFE channel audio signal to the audio output device 600 via the communication module 500, according to the playback layout information 430. The audio output device 600 may determine whether a height channel is required for audio playback according to the audio bitstream 10, based on the received audio signal. The audio output device 600 may play back audio via an appropriate channel layout, based on whether the height channel is required.

In the disclosure, a first audio signal may indicate a signal about audio to be played back via the LFE channel. The first audio signal may indicate the untransformed LFE channel audio signal 141 or 441, and may indicate the LFE channel audio signal 441 on which the modulation operation of FIG. 8 has not been performed.

In the disclosure, a second audio signal may indicate an LFE channel audio signal transformed from the first audio signal. A signal transformation scheme may vary, such as addition or modulation, and is not limited. The second audio signal may be different from the first audio signal. The second audio signal may indicate the LFE channel audio signal transformed by having the modulation operation of FIG. 8 performed thereon.

### 2. Operation of Audio Output Device 600

The audio output device 600 may process a transformed multi-channel audio signal, and may output the processed multi-channel audio signal. The audio output device 600 may obtain, via the communication module 500, an untransformed multi-channel audio signal or a multi-channel audio signal transformed by the audio processing device 400. The audio output device 600 may identify, from the untransformed multi-channel audio signal or the transformed multi-channel audio signal, whether a height channel is required, and may output audio based on the required channel layout.

In an embodiment of the disclosure, the audio output device 600 may include a low-pass filter 611 and a band-pass filter 612.

### 2.1. Application of Low-Pass Filter 611 in Audio Output Device 600

In an embodiment of the disclosure, the audio output device 600 may filter, via the low-pass filter 611, the LFE channel audio signal transformed by the audio processing device 400 or the LFE channel audio signal not transformed by the audio processing device 400.

In operation S40, the audio output device 600 may determine whether to transform the LFE channel audio signal, based on the LFE channel audio signal filtered by the low-pass filter 611. The audio output device 600 may determine whether the modulation operation has been performed, based on the LFE channel audio signal filtered by the low-pass filter 611.

The LFE channel audio signal may include a signal of a low frequency region, and thus, may be passed by the low-pass filter 611. The LFE channel audio signal on which the modulation operation has been performed based on the carrier signal 450 may include a signal of a relatively high frequency domain, and thus, may be blocked by the low-pass filter 611.

2.1.1. Case in which LFE Channel Audio Signal is not Transformed

In an embodiment of the disclosure, a case where there is an LFE channel audio signal passed by the low-pass filter 611 may indicate a case where a modulation operation is not performed on the LFE channel audio signal, and the LFE channel audio signal on which the modulation operation is not performed may be output via an LFE channel output port. The audio output device 600 may output audio according to the untransformed LFE channel audio signal via an LFE output port 621.

In an embodiment of the disclosure, a case where there is an LFE channel audio signal passed by the low-pass filter 611 may correspond to a case where a modulation operation is not performed on the LFE channel audio signal and may simultaneously indicate a case where there is no LFE channel audio signal passed by the band-pass filter 612. In other words, as the modulation operation is performed, the LFE channel audio signal may have a relatively high frequency domain, may be blocked by the low-pass filter 611, and may be passed by the band-pass filter 612.

According to a determination in operation S60 as to whether there is any LFE channel audio signal that has passed the band-pass filter 612, when there is no LFE channel audio signal passed by the band-pass filter 612, a 7-channel audio signal 442 may be output via a 7.0.0 channel output port 623. The audio output device 600 may output audio according to the 7-channel audio signal 442 via the 7.0.0 channel output port 623. As a result, when it is determined in operation S30 that the audio is not required to be played back via the 5.1.2 channel layout, the audio output device 600 may output the LFE channel audio output via the LFE output port 621 and the 7.0.0 channel audio output via the 7.0.0 channel output port 623. The audio output device 600 may output audio according to the 7.1.0 channel layout.

2.1.2. Case in which LFE Channel Audio Signal is Transformed

In an embodiment of the disclosure, in operation S40, a case where there is no LFE channel audio signal passed by the low-pass filter 611 may indicate a case where a modulation operation has been performed on an LFE channel audio signal. In this case, in operation S50, the audio output device 600 may determine whether there is an LFE channel audio signal filtered by the band-pass filter 612. The LFE channel audio signal on which the modulation operation has been performed may be passed by the band-pass filter 612. The audio output device 600 may perform a demodulation operation on the LFE channel audio signal passed by the band-pass filter 612, based on a carrier signal 650.

The carrier signal 650 used for the demodulation by the audio output device 600 may be equal to the carrier signal 450 used for the demodulation by the audio processing device 400. However, this is merely an example of performing an inverse operation and the disclosure is not limited thereto.

The audio output device 600 may output, via the LFE output port 621, audio according to the LFE channel audio signal on which the demodulation operation has been performed.

Also, according to the determination in operation S60, when there is the LFE channel audio signal passed by the band-pass filter 612, a 7-channel audio signal 442 may be output via a 5.0.2 channel output port 622. The audio output device 600 may output audio according to a 7-channel audio signal 442 via the 5.0.2 channel output port 622. As a result, when it is determined in operation S30 that the audio is required to be played back via the 5.1.2 channel layout, the audio output device 600 may output the LFE channel audio output via the LFE output port 621 and the 5.0.2 channel audio output via the 5.0.2 channel output port 622. The audio output device 600 may output audio according to the 5.1.2 channel layout.

In an embodiment of the disclosure, the audio processing device 400 configured to process the multi-channel audio signal and the audio output device 600 configured to output the multi-channel audio signal are separately described, but a portion or all of the operation performed by each device may be performed by the audio processing device 400 or may be performed by the audio output device 600.

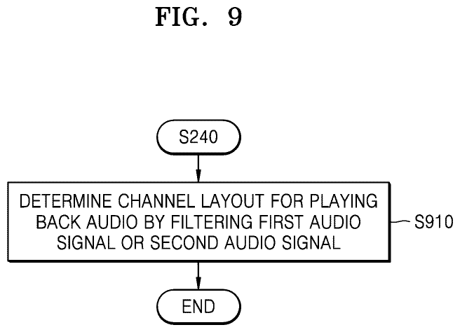

FIG. 9 is a flowchart for describing a method of classifying a multi-channel audio signal, according to an embodiment of the disclosure.

For convenience of descriptions, redundant descriptions with those provided with reference to FIG. 2 will be simplified or omitted.

Referring to FIG. 9, in operation S910, an electronic device may determine a channel layout for playing back audio by filtering a first audio signal or a second audio signal.

In an embodiment of the disclosure, the electronic device may filter the first audio signal or the second audio signal. The first audio signal may be an untransformed LFE channel audio signal, and the second audio signal may be a transformed LFE channel audio signal. The first audio signal may include a signal of a low frequency domain. The second audio signal may be a signal obtained by adding a preset signal of a relatively high frequency domain to the first audio signal. As another example, the second audio signal may be a signal obtained by performing a modulation operation on the first audio signal.

The electronic device may filter the first audio signal or the second audio signal by using a band-pass filter. The first audio signal may be blocked by the band-pass filter. A portion of the second audio signal may be blocked and another portion of the second audio signal may be passed by the band pass filter. The preset signal added to the second audio signal may be passed by the band-pass filter. As another example, a portion of the second audio signal on which a modulation operation has been performed may be passed by the band-pass filter.

Based on a result of filtering the first audio signal or the second audio signal by using the band-pass filter, whether the first audio signal or the second audio signal is filtered may be determined. When the first audio signal or the second audio signal is filtered by using the band-pass filter, whether the first audio signal has been transformed may be determined. When the first audio signal or the second audio signal is filtered by using the band-pass filter, whether it is required that audio has to be output via a channel layout including a height channel may be determined.

In an embodiment of the disclosure, the electronic device may be implemented as a device capable of outputting audio, such as a sound bar, a TV, a an audio output device.

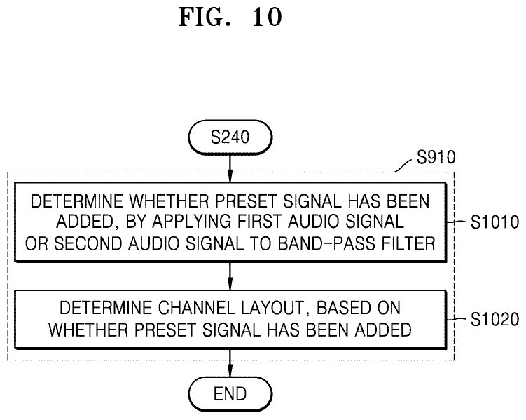

FIG. 10 is a flowchart for describing a method of classifying a multi-channel audio signal, according to an embodiment of the disclosure.

For convenience of descriptions, redundant descriptions with those provided with reference to FIGS. 2 and 9 will be simplified or omitted.

In an embodiment of the disclosure, operation S910 of FIG. 9 may include operations S1010 and S1020.

In operation S1010, the electronic device may determine whether the preset signal has been added, by applying the first audio signal or the second audio signal to the band-pass filter.

In an embodiment of the disclosure, the first audio signal may be blocked by the band-pass filter. A portion of the second audio signal may be blocked and another portion of the second audio signal may be passed by the band-pass filter. The preset signal added to the second audio signal may be passed by the band-pass filter.

When a signal passed by applying the first audio signal or the second audio signal to the band-pass filter is detected, it may be determined that the preset signal has been added. When the signal passed by applying the first audio signal or the second audio signal to the band-pass filter is not detected, it may be determined that the preset signal has not been added.

Thus, the electronic device may determine whether the preset signal has been added, by applying the first audio signal or the second audio signal to the band-pass filter.

In operation S1020, the electronic device may determine the channel layout, based on whether the preset signal has been added.

In an embodiment of the disclosure, when the preset signal has been added to the first audio signal to generate the second audio signal, it indicates that the audio needs to be output via the channel layout including the height channel. In this case, the electronic device may determine the channel layout including the height channel among various channel layouts.

For example, the electronic device may output the audio via the 5.1.2 channel layout including the height channel among the 8 channel layouts.

In an embodiment of the disclosure, when the preset signal has not been added to the first audio signal, it indicates that the audio does not need to be output via a channel layout including the height channel. In this case, the electronic device may determine the channel layout not including the height channel among various channel layouts.

For example, the electronic device may output the audio via the 7.1.0 channel layout not including the height channel among the 8 channel layouts.

In an embodiment of the disclosure, the electronic device may be implemented as a device capable of outputting audio, such as a sound bar, a TV, a mobile phone, a tablet PC, a notebook computer, etc. The electronic device may be an audio output device.

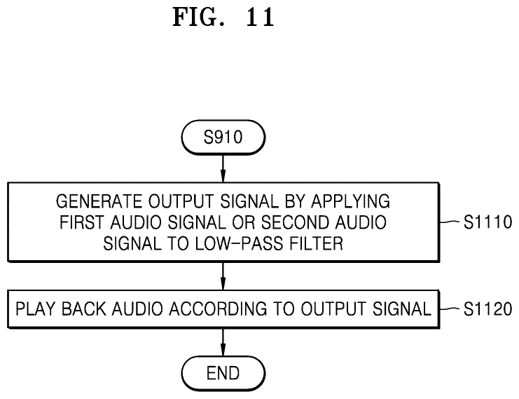

FIG. 11 is a flowchart for describing a method of playing back audio via an appropriate channel layout, based on a multi-channel audio signal, according to an embodiment of the disclosure.

For convenience of descriptions, redundant descriptions with those provided with reference to FIG. 9 will be simplified or omitted.

In operation S1110, the electronic device may generate an output signal by applying the first audio signal or the second audio signal to the low-pass filter.

In an embodiment of the disclosure, the first audio signal may be an LFE channel audio signal, and the second audio signal may be a signal obtained by adding the preset signal to the LFE channel audio signal. The preset signal may be blocked by the low-pass filter. By applying the first audio signal or the second audio signal to the low-pass filter, the LFE channel audio signal may be consistently obtained. The electronic device may apply the first audio signal or the second audio signal to the low-pass filter, thereby generating an output signal capable of being played back by the LFE channel.

In operation S1120, the electronic device may play back audio according to the output signal. The electronic device may play back audio according to the output signal via the LFE channel output port.

In an embodiment of the disclosure, the electronic device may play back audio according to the audio signals of channels other than the LFE channel. For example, when an 8-channel layout including the height channel is required, the electronic device may play back audio according to the 7-channel audio signal via the 5.0.2 channel output port. As another example, when an 8-channel layout not including the height channel is required, the electronic device may play back audio according to the 7-channel audio signal via the 7.0.0 channel output port.

In an embodiment of the disclosure, the electronic device may be implemented as a device capable of outputting audio, such as a sound bar, a TV, a an audio output device.

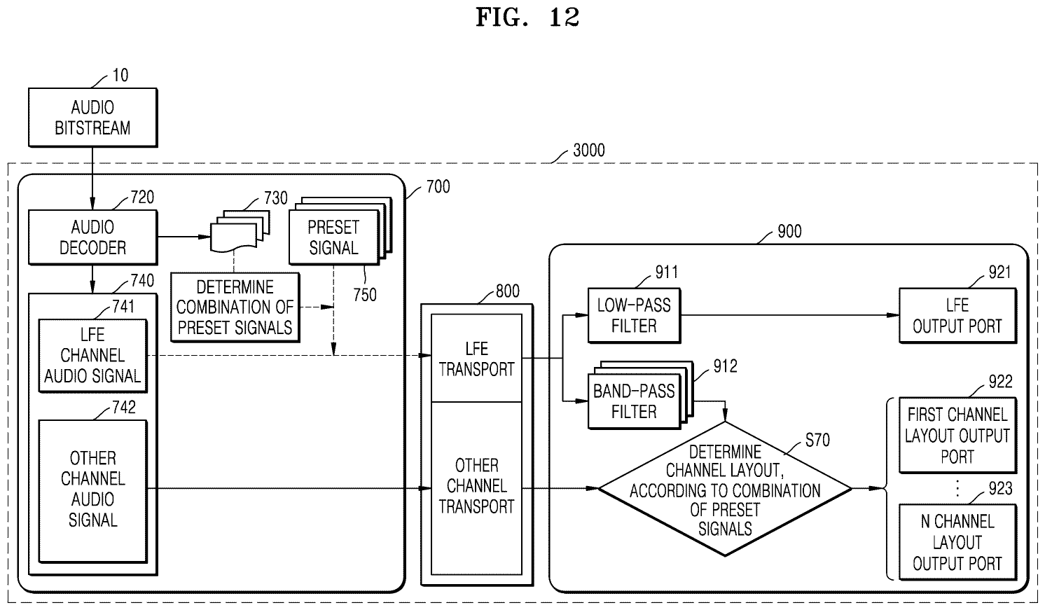

FIG. 12 is a conceptual diagram illustrating a system for classifying a multi-channel audio signal, according to an embodiment of the disclosure.

Redundant descriptions with those provided with reference to FIGS. 1 and 8 will be simplified or omitted.

Referring to FIG. 12, an audio processing system 3000 may include an audio processing device 700, a communication module 800, and an audio output device 900.

The audio processing device 700 may process a multi-channel audio signal. The audio processing device 700 may obtain a multi-channel audio signal and may transform audio signals of some channels among the multi-channel audio signals. The audio processing device 700 may transmit the transformed audio signals to the audio output device 900 via the communication module 800.

### 1. Operation of Audio Processing Device 700

The audio processing device 700 may transform an LFE channel audio signal 741, based on playback layout information 730. The audio processing device 700 may perform an operation of adding one or more preset signals 750 to the LFE channel audio signal 741.

The audio processing device 700 may determine a combination of the one or more preset signals 750 to be added to the LFE channel audio signal 741, based on the playback layout information 730. For example, the audio processing device 700 may add a first preset signal to the LFE channel audio signal 741, based on the playback layout information 730 specifying to play back audio according to a first channel layout. The audio processing device 700 may transmit, to the audio output device 900, the LFE channel audio signal 741 to which the first preset signal has been added.

As another example, the audio processing device 700 may add the first preset signal and a second preset signal to the LFE channel audio signal 741, based on the playback layout information 730 specifying to play back audio according to a second channel layout. The audio processing device 700 may transmit, to the audio output device 900, the LFE channel audio signal 741 to which the first preset signal and the second preset signal have been added.

In an embodiment of the disclosure, a combination of the one or more preset signals 750 added to the LFE channel audio signal 741 may correspond to a channel layout specified according to the playback layout information 730.

In an embodiment of the disclosure, the combination of the one or more preset signals 750 may represent binary information, based on whether a preset signal is added. The transformed LFE channel audio signal 741 obtained by adding the combination of the one or more preset signals 750 to the LFE channel audio signal 741 may include the binary information.

For example, the binary information corresponding to the combination of the one or more preset signals 750 may be summarized as Table 2 below. However, the relations below is merely an example, and the disclosure is not limited thereto. A method of using the combination of the one or more preset signals 750 will now be described in detail, with reference to Table 2.

TABLE 2

| Bit | channel layout |
|---|---|
| 000 | other signal |
| 001 | mono channel layout (1.0.0) |
| 010 | stereo channel layout (2.0.0) |
| 011 | 3.1.2 |
| 100 | 5.1.0 |
| 101 | 5.1.2 |
| 110 | 7.1.0 |
| 111 | — |

With Table 2, 8 channel layouts corresponding to combinations available with three preset signals are described. However, the number of preset signals and types of corresponding channel layouts are not limited, and more preset signals may be used to correspond to available channel layouts.

In an embodiment of the disclosure, the audio processing device 700 may add a combination of a first preset signal, a second preset signal, and a third preset signal to the LFE channel audio signal 741. Based on whether each preset signal being added to the LFE channel audio signal 741, 0 or 1 may be determined to be in each digit of the binary representation of numbers. When a preset signal is added to the LFE channel audio signal 741, 1 may be determined to be in a corresponding digit in the binary representation of numbers.

For example, the audio processing device 700 may add a first combination including a first preset signal and a second preset signal to the LFE channel audio signal 741. In this case, information represented via a binary system may be ‘110’. Therefore, the audio processing device 700 may add the first combination including the first preset signal and the second preset signal to the LFE channel audio signal 741, thereby transmitting information indicating to play back audio via a 7.1.0 channel layout. The audio output device 900 may receive the information indicating to play back audio via the 7.1.0 channel layout, from the LFE channel audio signal 741 to which the first combination including the first preset signal and the second preset signal has been added.

As another example, the audio processing device 700 may add a second combination of the first preset signal and a third preset signal to the LFE channel audio signal 741. In this case, information represented via a binary system may be ‘101’. Therefore, the audio processing device 700 may add the second combination of the first preset signal and the third preset signal to the LFE channel audio signal 741, thereby transmitting information indicating to play back audio via a 5.1.2 channel layout. The audio output device 900 may receive the information indicating to play back audio via the 5.1.2 channel layout, from the LFE channel audio signal 741 to which the second combination of the first preset signal and the third preset signal has been added.

In an embodiment of the disclosure, when a preset signal is not added to the LFE channel audio signal 741, information represented via a binary system may be ‘000’. A channel layout corresponding to ‘000’ may indicate other signal. The LFE channel audio signal 741 to which the preset signal has not been added may be recognized as the other signal. LFE channel audio signals to which the preset signal has not been added by the audio processing device 700 may be recognized as other signals. For example, an LFE channel audio signal transmitted not from the audio processing device 700 but from an external audio device may be recognized as other signal.

In an embodiment of the disclosure, when the first preset signal, the second preset signal, and the third preset signal are added to the LFE channel audio signal 741, information represented via a binary system may be ‘111’. In Table 2, a channel layout corresponding to ‘111’ is not specified. Another channel layout may be specified to correspond to ‘111’, and a corresponding channel layout may be empty. For example, when it is required to specify a new channel layout, ‘111’ may correspond to the new channel layout, but the disclosure is not limited thereto.

### 2. Operation of Audio Output Device 900

The audio output device 900 may process a transformed multi-channel audio signal, and may output the processed multi-channel audio signal. The audio output device 900 may obtain, via the communication module 800, a multi-channel audio signal transformed by the audio processing device 700. The audio output device 900 may identify a corresponding channel layout from the transformed multi-channel audio signal, and may output audio, based on the required channel layout.

According to an embodiment of the disclosure, the audio output device 900 may include a low-pass filter 911 and one or more band-pass filters 912.

### 2.1. Application of Low-Pass Filter 911 in Audio Output Device 900

In an embodiment of the disclosure, the audio output device 900 may filter, via the low-pass filter 911, the LFE channel audio signal transformed by the audio processing device 700.

The transformed LFE channel audio signal may be an audio signal to which the combination of the one or more preset signals 750 is added. The preset signal 750 may be blocked by the low-pass filter 911, and the audio output device 900 may restore the LFE channel audio signal 741 by applying the transformed LFE channel audio signal to the low-pass filter 911.

The audio output device 900 may restore the LFE channel audio signal 741 by applying the transformed LFE channel audio signal to the low-pass filter 911. When the LFE channel audio signal 741 to which the combination of the one or more preset signals 750 has been added is transmitted to the audio output device 900, the audio output device 900 may selectively remove the combination of the one or more preset signals 750 via the low-pass filter 911.

The audio output device 900 may output audio according to the LFE channel audio signal 741 via an LFE output port 921. The LFE channel audio signal 741 may be output via the LFE channel. For example, the LFE channel audio signal 741 may be played back via a subwoofer speaker.

### 2.2. Application of Band-Pass Filter 912 in Audio Output Device 900

In an embodiment of the disclosure, the audio output device 900 may filter, via the one or more band-pass filters 912, the LFE channel audio signal transformed by the audio processing device 700.

The audio output device 900 according to an embodiment of the disclosure may determine whether the one or more preset signals 750 have been added, based on the LFE channel audio signal filtered by the one or more band-pass filters 912. The audio output device 900 may identify the combination of the one or more preset signals 750.

In an embodiment of the disclosure, the one or more band-pass filters 912 may include a first band-pass filter, a second band-pass filter, and a third band-pass filter. The first band-pass filter may be a filter configured to pass a frequency domain corresponding to a first preset signal. The second band-pass filter may be a filter configured to pass a frequency domain corresponding to a second preset signal. The third band-pass filter may be a filter configured to pass a frequency domain corresponding to a third preset signal. The audio output device 900 may determine whether the transformed LFE channel audio signal includes the first preset signal, the second preset signal, and the third preset signal, by using the first band-pass filter, the second band-pass filter, and the third band-pass filter, respectively.

According to an embodiment of the disclosure, the audio output device 900 may filter the LFE channel audio signal via the first band-pass filter. As a result of the filtering, when a signal is identified, it may be determined that the LFE channel audio signal includes the first preset signal. As the result of the filtering, when the signal is not identified, it may be determined that the LFE channel audio signal does not include the first preset signal.

Similarly, the audio output device 900 may filter the LFE channel audio signal via the second band-pass filter. The audio output device 900 may filter the LFE channel audio signal via the third band-pass filter. According to results of filtering the LFE channel audio signal via the one or more band-pass filters 912, the audio output device 900 may determine a combination of one or more preset signals added to the LFE channel audio signal.

In operation S70, the audio output device 900 may determine a channel layout, according to a combination of the one or more preset signals added to the LFE channel audio signal.

According to an embodiment of the disclosure, the audio output device 900 may obtain binary information according to the determined combination of the one or more preset signals. The audio output device 900 may obtain a channel layout corresponding to the binary information.

For example, the audio output device 900 may identify the first combination including the first preset signal and the second preset signal, by filtering the LFE channel audio signal 741 via the one or more band-pass filters 912. In this case, information represented via a binary system may be ‘110’. Therefore, the audio output device 900 may receive, from the first combination including the first preset signal and the second preset signal, the information indicating to play back audio via a 7.1.0 channel layout. The audio output device 900 may play back the LFE channel audio signal 741 via the LFE output port 921, and may play back other channel audio signal 742 via a 7.0.0 channel layout output port. For example, a first channel layout output port 922 may be the 0.0 channel layout output port.

As another example, the audio output device 900 may identify the second combination including the first preset signal and the third preset signal, by filtering the LFE channel audio signal 741 via the one or more band-pass filters 912. In this case, information represented via a binary system may be ‘101’. Therefore, the audio output device 900 may receive, from the second combination including the first preset signal and the third preset signal, the information indicating to play back audio via a 5.1.2 channel layout. The audio output device 900 may play back the LFE channel audio signal 741 via the LFE output port 921, and may play back other channel audio signal 742 via a 5.0.2 channel layout output port. For example, an N channel layout output port 923 may be the 5.0.2 channel layout output port.

In an embodiment of the disclosure, the audio processing device 700 configured to process the multi-channel audio signal and the audio output device 900 configured to output the multi-channel audio signal are separately described, but a portion or all of the operation performed by each device may be performed by the audio processing device 700 or may be performed by the audio output device 900.

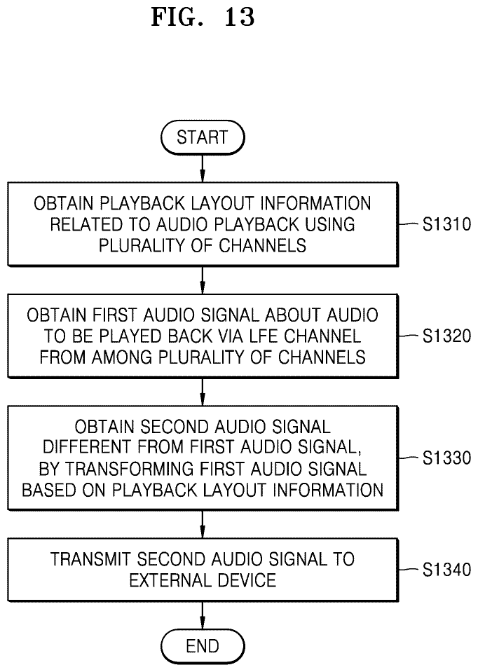

FIG. 13 is a flowchart for describing an audio processing method for classifying a multi-channel audio signal, according to an embodiment of the disclosure. For convenience of descriptions, redundant descriptions with those provided with reference to FIG. 2 will be simplified or omitted.

Referring to FIG. 13, in operation S1310, the electronic device may obtain playback layout information related to audio playback using a plurality of channels. Descriptions of operation S1310 may be redundant to those of operation S210 in FIG. 2, and thus, may not be provided here.

In operation S1320, the electronic device may obtain a first audio signal about audio to be played back via an LFE channel from among a plurality of channels. Descriptions of operation S1320 may be redundant to those of operation S220 in FIG. 2, and thus, may not be provided here.

In operation S1330, the electronic device may obtain a second audio signal different from the first audio signal, by transforming the first audio signal based on the playback layout information.

In an embodiment of the disclosure, the electronic device may obtain the second audio signal by adding one or more preset signals to the first audio signal. Based on whether the one or more preset signals have been added, binary information may be added to the first audio signal.

For example, the electronic device may determine whether to add one preset signal to the first audio signal. The electronic device may generate information of ‘1’ or ‘0’, according to whether one preset signal has been added to the first audio signal.

As another example, the electronic device may add one of combinations of two preset signals to the first audio signal. The electronic device may generate information of ‘11’, ‘10’, ‘01’, or ‘00’, according to a combination of the two preset signals which has been added to the first audio signal.

As another example, the electronic device may add one of combinations of three preset signals to the first audio signal. The electronic device may generate information of ‘111’, ‘110’, ‘101’, ‘100’, ‘011’, ‘010’, ‘001’, or ‘000’, according to a combination of the three preset signals which has been added to the first audio signal.

In an embodiment of the disclosure, the second audio signal may be an audio signal to which one or more preset signals have been added to the first audio signal. The added one or more preset signals may be interpreted as binary information.

According to an embodiment of the disclosure, combinations of the one or more preset signals may respectively correspond to channel layouts for playing back audio. Binary information interpreted from a combination of the one or more preset signals may correspond to a channel layout for playing back audio. Based on the combination of the one or more preset signals added to the first audio signal, the electronic device may transmit information about the channel layout via which audio has to be played back.

In operation S1340, the electronic device may transmit the second audio signal to an external device. Descriptions of operation S1340 may be redundant to those of operation S240 in FIG. 2, and thus, may be briefly provided.

In an embodiment of the disclosure, the electronic device may transmit the second audio signal to the external device via a communication device. For example, the electronic device may transmit the second audio signal to an audio output device via an HDMI.

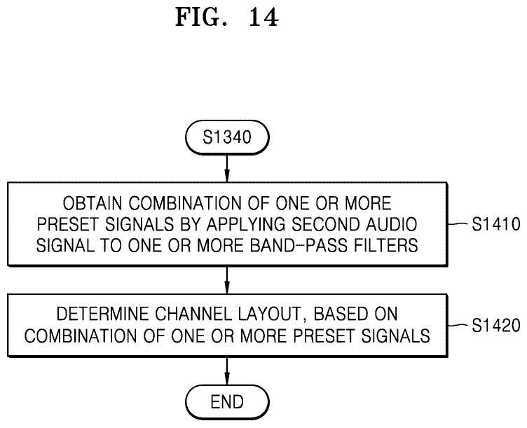

FIG. 14 is a flowchart for describing a method of classifying a multi-channel audio signal, according to an embodiment of the disclosure. For convenience of descriptions, redundant descriptions with those provided with reference to FIG. 13 will be simplified or omitted.

Referring to FIG. 14, operation S1410 may be performed after operation S1340 of FIG. 13.

In operation S1410, the audio output device may obtain a combination of one or more preset signals by applying the second audio signal to one or more band-pass filters.

In an embodiment of the disclosure, the audio output device may filter the second audio signal via the one or more band-pass filters. The second audio signal may include the first audio signal (e.g., the LFE channel audio signal) and the one or more preset signals. The first audio signal may be blocked by a band-pass filter, and the one or more preset signals may pass through the band-pass filter.

In an embodiment of the disclosure, the audio output device may include the one or more band-pass filters respectively corresponding to frequency domains of the one or more preset signals. The audio output device may determine whether each of the one or more preset signals is included, by applying the one or more band-pass filters to the second audio signal.

For example, the audio output device may determine whether the first preset signal is included, by applying the first band-pass filter to the second audio signal. The audio output device may determine whether the second preset signal is included, by applying the second band-pass filter to the second audio signal. The audio output device may determine whether the third preset signal is included, by applying the third band-pass filter to the second audio signal. The number of band-pass filters may correspond to the number of preset signals which are applicable to the second audio signal, but the number of band-pass filters or the number of preset signals is not limited.

According to an embodiment of the disclosure, based on whether one or more preset signals have been added to the second audio signal, the audio output device may obtain a combination of the one or more preset signals.

In operation S1420, the audio output device may determine a channel layout, based on the combination of the one or more preset signals.

In an embodiment of the disclosure, the combinations of the one or more preset signals may respectively correspond to channel layouts for playing back audio. The combinations of the one or more preset signals may be represented as binary information.

For example, the audio processing device may generate the second audio signal, based on the first preset signal, the second preset signal, and the third preset signal. The audio processing device may generate the second audio signal by applying a combination of the first preset signal, the second preset signal, and the third preset signal to the first audio signal. For example, according to whether each of the first preset signal, the second preset signal, and the third preset signal is included, a total of 8 combinations is available.

For example, the audio processing device may generate the second audio signal by adding the first combination including the first preset signal and the second preset signal to the first audio signal. In this case, information represented via a binary system may be ‘110’. As another example, the audio processing device may generate the second audio signal by adding the second combination including the first preset signal and the third preset signal to the first audio signal. In this case, information represented via a binary system may be ‘101’.

In an embodiment of the disclosure, the audio processing device may transmit the generated second audio signal to the audio output device.

In an embodiment of the disclosure, binary information obtainable from a combination of one or more preset signals may correspond to a channel layout for playing back audio. The audio output device may play back the audio via the channel layout corresponding to the combination of the one or more preset signals.

For example, the audio output device may identify that the second audio signal includes the combination of the first preset signal and the second preset signal. The audio output device may obtain binary information of ‘110’. For example, the audio output device may play back the audio via a 7.1.0 channel layout corresponding to ‘110’.

As another example, the audio output device may identify that the second audio signal includes the combination of the first preset signal and the third preset signal. The audio output device may obtain binary information of ‘101’. For example, the audio output device may play back the audio via a 5.1.2 channel layout corresponding to ‘101’.

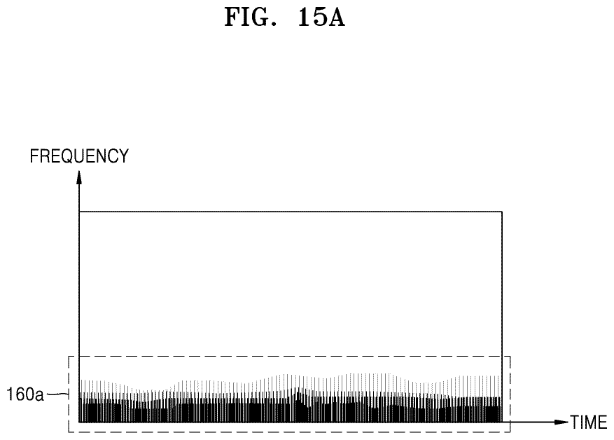

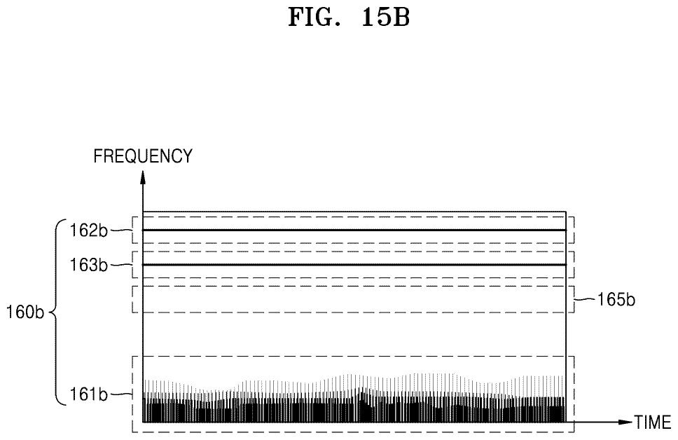

FIG. 15A is a graph for describing a first audio signal about audio to be played back via an LFE channel, according to an embodiment of the disclosure. FIG. 15B is a graph for describing a second audio signal different from the first audio signal, according to an embodiment of the disclosure.

For reference, FIGS. 15A and 15B illustrate frequency-time graphs of an LFE channel audio signal among a multi-channel audio signal transmitted from an audio processing device to an audio output device, according to an embodiment of the disclosure. In detail, FIG. 15A is the graph of an untransformed LFE channel audio signal, and FIG. 15B is the graph of an LFE channel audio signal transformed by adding one or more preset signals thereto.

For reference, FIG. 15A is merely a diagram for comparison with FIG. 15B and may be the same as FIG. 6A, and as related descriptions may be the same, descriptions thereof may be simply provided.

Referring to FIG. 15A, the graph of an untransformed LFE channel audio signal 160a is illustrated. The LFE channel audio signal 160a may be an audio signal that may be played back via a channel for outputting a low frequency effect sound. The LFE channel audio signal 160a may occur in a low frequency domain. The LFE channel audio signal 160a may include an audio signal having a low-band frequency. For example, the LFE channel audio signal 160a may include an audio signal of a frequency band less than 400 Hz.

Referring to FIG. 15B, the graph of an LFE channel audio signal 160b transformed by adding a preset signal thereto is illustrated. The transformed LFE channel audio signal 160b may include an original LFE channel audio signal 161b and one or more preset signals 162b and 163b including the first preset signal 162b and the second preset signal 163b. The transformed LFE channel audio signal 160b may correspond to a combination of the original LFE channel audio signal 161b and the one or more preset signals 162b and 163b.

In an embodiment of the disclosure, the original LFE channel audio signal 161b may indicate an LFE channel audio signal before the one or more preset signals 162b and 163b are added thereto, and may be equal to the untransformed LFE channel audio signal 160a of FIG. 15A.

In an embodiment of the disclosure, the one or more preset signals 162b and 163b may be signals having a frequency domain different from that of the LFE channel audio signal 161b. The one or more preset signals 162b and 163b may be signals having high frequency domain bands different from a low frequency domain band of an LFE channel. For example, frequency domains of the one or more preset signals 162b and 163b may not overlap a frequency domain of the LFE channel.

In an embodiment of the disclosure, frequency domains of preset signals may not overlap each other. A frequency domain of the first preset signal 162b may not overlap a frequency domain of the second preset signal 163b. The first preset signal 162b may be different from the second preset signal 163b. The audio output device may identify a combination of one or more preset signals by determining whether the first preset signal 162b and the second preset signal 163b having different frequency domains are included, and may determine a channel layout corresponding to the combination of one or more preset signals. The audio output device may play back audio according to the determined channel layout.

In an embodiment of the disclosure, binary information of ‘1’ or ‘0’ may be determined according to whether a preset signal is included in the LFE channel audio signal 160b. Describing the case of FIG. 15B as an example, as the first preset signal 162b is included in the LFE channel audio signal 160b, ‘1’ may be determined to be in a first digit of integer numbers of a binary system. As the second preset signal 163b is included in the LFE channel audio signal 160b, ‘1’ may be determined to be in a second digit of the integer numbers of the binary system. As the LFE channel audio signal 160b does not include a third preset signal in a frequency domain band 165b in which the third preset signal may be positioned, ‘0’ may be determined to be in a third digit of the integer numbers of the binary system. As a result, the LFE channel audio signal 160b may include binary information of ‘110’.

The audio output device may play back audio via a channel layout corresponding to the binary information. The binary information of ‘110’ described to be included in the LFE channel audio signal 160b with reference to FIG. 15B is merely an example, and combinations of various preset signals according to Table 2 or any other form may be added to the LFE channel audio signal 160b. The LFE channel audio signal 160b may include information about various channel layouts.

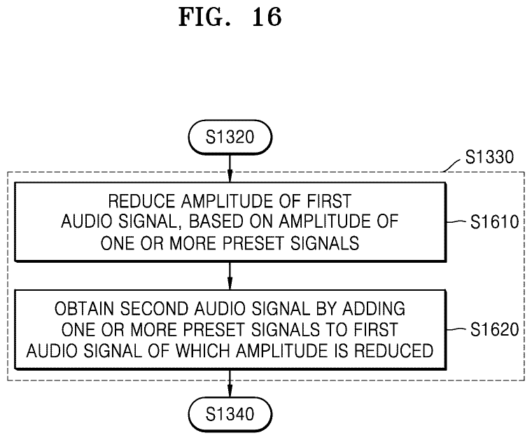

FIG. 16 is a flowchart for describing a method of generating a second audio signal by pre-processing a first audio signal, according to an embodiment of the disclosure. For convenience of descriptions, what are described or redundant with those of FIG. 13 may be simply provided or may not be provided.

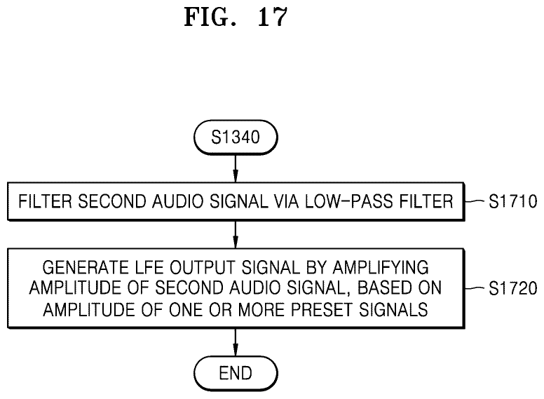

For reference, FIG. 16 illustrates a pre-processing operation of reducing an amplitude of an audio signal, and FIG. 17 illustrates a post-processing operation of restoring an amplitude of a pre-processed audio signal.

Referring to FIG. 16, operation S1330 of FIG. 13 may include operation S1610 and operation S1620.

In operation S1610, the electronic device may reduce an amplitude of a first audio signal, based on an amplitude of one or more preset signals.

In an embodiment of the disclosure, when the second audio signal is generated by adding a preset signal to the first signal, an amplitude of the second audio signal may exceed a maximum allowance range of an audio system. Accordingly, the electronic device may reduce an amplitude of the first audio signal in advance.

In an embodiment of the disclosure, the electronic device may reduce the amplitude of the first audio signal, based on the amplitude of the one or more preset signals. When the amplitude of the second audio signal obtained by adding the preset signal to the first audio signal exceeds an allowance range of the audio system, the exceeding amplitude of the second audio signal may be proportional to the amplitude of the one or more preset signals. Therefore, the electronic device may reduce the amplitude of the first audio signal in advance, in proportion to the amplitude of the one or more preset signals.

In this regard, that an amplitude of an audio signal is reduced may be expressed that the audio signal is suppressed or attenuated, and the expressions or terms do not limit the disclosure.

In operation S1620, the electronic device may obtain the second audio signal by adding the one or more preset signals to the first audio signal of which amplitude is reduced. Descriptions of operation S1620 may be redundant to those of operation S1330 in FIG. 13, and thus, may not be provided here.

FIG. 17 is a flowchart for describing a method of restoring a first audio signal before pre-processing, by post-processing a second audio signal, according to an embodiment of the disclosure. For convenience of descriptions, redundant descriptions with those provided with reference to FIG. 13 will be simplified or omitted.

Referring to FIG. 17, operation S1710 and operation S1720 may be performed after operations S1340 of FIG. 13.

In operation S1710, the electronic device may filter the second audio signal via a low-pass filter.

In an embodiment of the disclosure, the second audio signal may be an audio signal obtained by adding a preset signal to the first audio signal. The second audio signal may be an audio signal obtained by adding a combination of one or more preset signals to the first audio signal. For example, the second audio signal may correspond to a combination of the first audio signal and the one or more preset signals. The first audio signal may include an LFE channel audio signal among a multi-channel audio signal.

In an embodiment of the disclosure, the audio output device may obtain an audio signal of a low frequency band by filtering the second audio signal via the low-pass filter. By filtering the second audio signal, the first audio signal may be passed and the one or more preset signals may be blocked. For example, the audio output device may obtain the LFE channel audio signal by filtering the second audio signal via the low-pass filter. Simultaneously, the audio output device may block the one or more preset signals by filtering the second audio signal via the low-pass filter.

In operation S1720, the audio output device may generate an LFE output signal by amplifying an amplitude of the second audio signal, based on an amplitude of the one or more preset signals.

In an embodiment of the disclosure, when the second audio signal is generated by adding a preset signal to the first audio signal, an amplitude of the second audio signal may exceed a maximum allowance range of an audio system. Accordingly, the audio processing device may reduce an amplitude of the first audio signal in advance. The audio processing device may obtain the second audio signal by transforming the first audio signal of which amplitude is reduced. The audio processing device may transmit the obtained second audio signal to the audio output device.

The audio output device may amplify again the amplitude of the second audio signal, based on the amplitude-reduced first audio signal. Therefore, the audio output device may not exceed a maximum allowance range of the audio system, and may restore the first audio signal of which amplitude is maintained.

In an embodiment of the disclosure, the audio output device may amplify the amplitude of the second audio signal, based on an amplitude of the one or more preset signals.

The audio output device may obtain the second audio signal by adding a preset signal to the first audio signal of which amplitude is reduced in operation S1610. The audio output device may filter the second audio signal via the low-pass filter. By applying the low-pass filter to the second audio signal, the first audio signal may be passed and the one or more preset signals may be blocked. For example, the filtered second audio signal may be an audio signal equal to the first audio signal.

The filtered second audio signal may be in a state in which the amplitude is reduced, and a reduction level of the amplitude of the filtered second audio signal may be proportional to the amplitude of the one or more preset signals. The reduction level of the amplitude of the filtered second audio signal may be proportional to the amplitude of the one or more preset signals that are blocked by the low-pass filter. The audio output device may amplify the amplitude of the filtered second audio signal, in proportion to the amplitude of the one or more preset signals.

In an embodiment of the disclosure with reference to FIGS. 16 and 17, the amplitude of the first audio signal may be reduced before the one or more preset signals are added. Afterward, the amplitude of the second audio signal transmitted to the audio output device is amplified again, such that the LFE output signal may be generated. By doing so, a clipping phenomenon that is a distortion phenomenon which occurs when the maximum allowance range of the audio system is exceeded due to addition of a preset signal to an audio signal may be prevented.

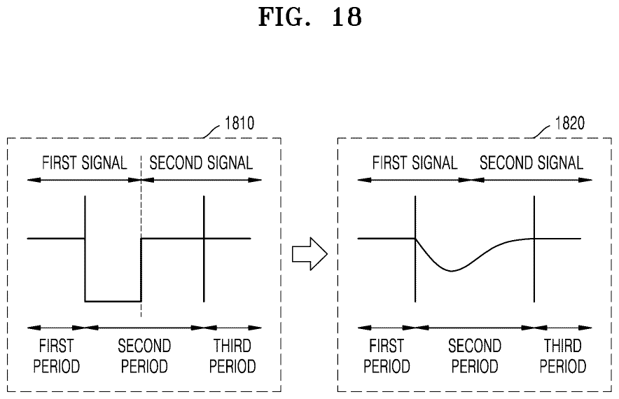

FIG. 18 is a flowchart for describing a method of interpreting a plurality of audio signals, by post-processing discontinuity between two input audio signals.

FIG. 18 show a first graph 1810 and a second graph 1820 that illustrate a form of an LFE channel audio signal output from the audio output device. For reference, in the graph of FIG. 18, a vertical axis represents an amplitude of a signal and a horizontal axis represents a time. With reference to FIG. 18, a problem that occurs before the LFE channel audio signal is post-processed will now be described with reference to the first graph 1810, and pre-processing the LFE channel audio signal to solve the problem will now be described with reference to the second graph 1820.

Referring to the first graph 1810 of FIG. 18, the audio output device may receive a first signal and a second signal.

In an embodiment of the disclosure, the first signal may include an audio signal obtained by adding one or more preset signals to an LFE channel audio signal transmitted by the audio processing device. The first signal may indicate the LFE channel audio signal obtained again by filtering the audio signal via a low-pass filter, the audio signal being obtained by adding a combination of the one or more preset signals to the LFE channel audio signal.

In an embodiment of the disclosure, the first signal may be classified according to a first period and a second period. The first period may indicate a past time point at which the first signal has been post-processed and output by the audio output device. In other words, the first signal in the first period has been already output by the audio output device. The second period may indicate a current time point at which the first signal is received by the audio output device. The first signal in the second period may indicate an audio signal before it is post-processed. Here, post-processing indicates that an amplitude is amplified according to operation S1720 of FIG. 17.

In an embodiment of the disclosure, the first signal in the first period may include an audio signal obtained by amplifying an amplitude of the LFE channel audio signal according to operation S1720. That the amplitude of the LFE channel audio signal is amplified may indicate that an operation of reducing the amplitude in operation S1610 is offset. In the first period, the audio output device may output the LFE channel audio signal of which amplitude is restored.

In an embodiment of the disclosure, the second signal may include an audio signal received from an external audio device. The second signal may include the audio signal to which a preset signal is not added. For example, the second signal may be other signal described in Table 2, and may be the audio signal represented as ‘000’ because the preset signal is not added thereto.

In an embodiment of the disclosure, the second signal may be classified according to a second period and a third period. The second period may indicate a current time point at which the second signal is received by the audio output device. The second signal in the second period may indicate an audio signal before it is post-processed. Here, post-processing indicates that an amplitude is amplified according to operation S1720 of FIG. 17. The third period may indicate a future time point at which the second signal is not input to the audio output device.

In an embodiment of the disclosure, the audio output device may sequentially receive an audio signal. The audio output device may segment the sequential audio signal into frames. The audio output device may obtain information of the audio signal for each frame, and may output audio corresponding to the audio signal. The third period may indicate frames of the future time point at which the frames are not yet recognized by the audio output device.

The audio output device may sequentially receive the audio signal and recognize each frame, but may not distinguish between the first signal and the second signal. Accordingly, the audio output device may obtain information of the audio signal corresponding to a frame of the second period. In the second period, the audio output device may not distinguish between the first signal and the second signal within the second period.

For reference, a time point corresponding to an audio signal of the second period is interpreted as a current time at which audio corresponding to the first signal included in the first period has been output and audio corresponding to the second signal included in the third period is not output yet.

In an embodiment of the disclosure, the first signal in the second period indicates an LFE channel audio signal obtained in a manner that the amplitude of the first audio signal is reduced according to operation S1610 of FIG. 16, the second audio signal is obtained by adding the preset signal to the first audio signal of which amplitude has been reduced, and the second audio signal is transmitted to the audio output device and then passes through the low-pass filter so as to be the LFE channel audio signal.

Due to an operation of reducing an amplitude of the first audio signal, an amplitude of the first signal within the second period may be different from an amplitude of the first signal of the first period and an amplitude of the second signal within the second period. The first signal of the first period may be a signal to which an operation of amplifying an amplitude of the second audio signal has been applied according to operation S1720 and then has been output, and thus, may have an amplitude higher than an amplitude of the first signal of the second period. The second signal of the second period may be an audio signal to which an operation of reducing an amplitude has not been performed according to operation S1610 and which is from an external audio device, and thus, may have an amplitude higher than the amplitude of the first signal of the second period. Therefore, amplitudes are not matched between an end portion of the first signal of the first period and a beginning portion of the first signal of the second period, and also between an end portion of the first signal of the second period and a beginning portion of the second signal in the second period.

Also, when an operation of amplifying an amplitude of an audio signal is applied to the second period according to operation S1720, a problem occurs, in which the amplitude of the first signal of the first period may match the amplitude of the first signal of the second period but the amplitude of the second signal of the second period does not match the amplitude of the second signal of the third period.

Therefore, referring to the second graph 1820 of FIG. 18, the audio output device may apply a smoothing filter to an audio signal of the second period. The smoothing filter may decrease a sharp change in an amplitude of the audio signal. For example, the audio output device may calculate an average of amplitudes of the audio signal within a preset range by using the smoothing filter and may generate an audio signal having a new amplitude value. However, a scheme of smoothing an audio signal is merely an example, and the disclosure is not limited thereto.

In an embodiment of FIGS. 16 and 17, the electronic device may control an amplitude of an audio signal so as to prevent a clipping phenomenon. As a result, a discontinuity phenomenon may occur between an audio signal in a frame recognized by the audio output device and an audio signal outside the frame. In an embodiment of FIG. 18, the audio output device may prevent the discontinuity phenomenon by applying the smoothing filter to the audio signal.

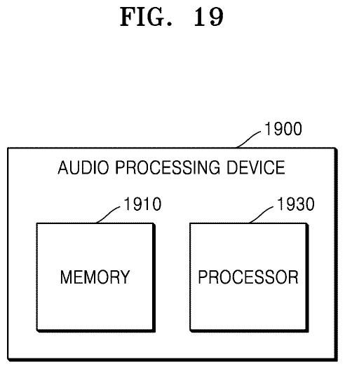

FIG. 19 is a diagram for describing a configuration of an audio processing device for processing a multi-channel audio signal, according to an embodiment of the disclosure.

An audio processing device 1900 may include at least one memory 1910 and at least one processor 1930. However, the elements of the audio processing device 1900 are not limited to the example above, and the audio processing device 1900 may include more elements or fewer elements than the aforementioned elements.

The audio processing device 1900 may be implemented as a device capable of audio processing, such as a server, a TV, a camera, a mobile phone, a tablet PC, or a notebook computer.

Although the at least one memory 1910 and the at least one processor 1930 are separately illustrated in FIG. 19, the at least one memory 1910 and the at least one processor 1930 may be implemented via a single hardware module (e.g., a chip).

As a configuration for storing various programs or data, the at least one memory 1910 may include a storage medium or a combination of storage media such as ROMs, RAMs, hard disks, CD-ROMs, and DVDs. The at least one memory 1910 may not be separately provided and may be included in the at least one processor 1930. The at least one memory 1910 may include a volatile memory, a non-volatile memory, or a combination of a volatile memory and a non-volatile memory. The at least one memory 1910 may store a program or instructions for performing the operations according to the embodiments of the disclosure described above with reference to FIGS. 1 to 18. The at least one memory 1910 may provide the stored data to the at least one processor 1930, in response to the request of the at least one processor 1930.

It should be understood that blocks in each flowchart and combinations of flowcharts may be performed by one or more computer programs including computer-executable instructions. The one or more computer programs may be all stored in one memory, or may be stored in a plurality of different memories in a distributed manner.

The at least one processor 1930 may include one or more processors as a configuration for controlling a series of processes such that the audio processing device 1900 operates according to the embodiments of the disclosure described above with reference to FIGS. 1 to 18. The one or more processors included in the at least one processor 1930 may be circuitry such as a system on chip (SoC), integrated circuit (IC), or the like. In this case, the one or more processors may include a general-purpose processor such as a central processing unit (CPU), an application processor (AP), or a digital signal processor (DSP), a graphic-dedicated processor such as a graphic processing unit (GPU) or a vision processing unit (VPU), or an artificial intelligence-dedicated processor such as a neural processing unit (NPU). For example, when the one or more processors include an artificial intelligence-dedicated processor, the artificial intelligence-dedicated processor may be designed with a hardware structure specialized for processing of a particular artificial intelligence model.

The at least one processor 1930 may write data to the at least one memory 1910 or read data stored in the at least one memory 1910, and more particularly, may execute a program or at least one instruction stored in the at least one memory 1910 to process data according to a predefined operation rule or an artificial intelligence model. Therefore, the at least one processor 1930 may perform operations to be described in embodiments below, and in the embodiments below, operations described to be performed by the audio processing device 1900 or configurations included in the audio processing device 1900 may be performed by the at least one processor 1930, unless there is a particular description contrary thereto.

The at least one memory 1910 may store one or more instructions for audio processing. According to the instruction stored in the at least one memory 1910, the at least one processor 1930 may obtain a first audio signal about audio to be played back via an LFE channel, and may obtain a second audio signal by transforming the first audio signal, based on playback layout information. According to the instruction stored in the at least one memory 1910, the at least one processor 1930 may transmit the second audio signal transformed from the first audio signal.

The at least one processor 1930 may perform at least some of the functions of the audio processing device 100, 400, or 700 of FIG. 1, 8, or 12.

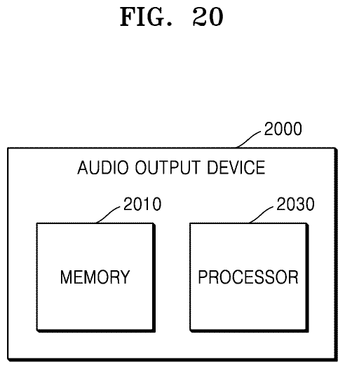

FIG. 20 is a diagram for describing a configuration of an electronic device for outputting a multi-channel audio signal, according to an embodiment of the disclosure.

An audio output device 2000 may include at least one memory 2010 and at least one processor 2030. However, the elements of the audio output device 2000 are not limited to the example above, and the audio output device 2000 may include more elements or fewer elements than the aforementioned elements.

The audio output device 2000 may be implemented as a device capable of audio output, such as a sound bar, a TV, a mobile phone, a tablet PC, or a notebook computer.

Although the at least one memory 2010 and the at least one processor 2030 are separately illustrated in FIG. 20, the at least one memory 2010 and the at least one processor 2030 may be implemented via a single hardware module (e.g., a chip).

As a configuration for storing various programs or data, the at least one memory 2010 may include a storage medium or a combination of storage media such as ROMs, RAMs, hard disks, CD-ROMs, and DVDs. The at least one memory 2010 may not be separately provided and may be included in the at least one processor 2030. The at least one memory 2010 may include a volatile memory, a non-volatile memory, or a combination of a volatile memory and a non-volatile memory. The at least one memory 2010 may store a program or instructions for performing the operations according to the embodiments of the disclosure described above with reference to FIGS. 1 to 18. The at least one memory 2010 may provide the stored data to the at least one processor 2030, in response to the request of the at least one processor 2030.

The at least one processor 2030 may include one or more processors as a configuration for controlling a series of processes such that the audio output device 2000 operates according to the embodiments of the disclosure described above with reference to FIGS. 1 to 18. In this case, the one or more processors may include a general-purpose processor such as a CPU, an AP, or a DSP, a graphic-dedicated processor such as a GPU or a VPU, or an artificial intelligence-dedicated processor such as a NPU. For example, when the one or more processors include an artificial intelligence-dedicated processor, the artificial intelligence-dedicated processor may be designed with a hardware structure specialized for processing of a particular artificial intelligence model.

In an embodiment of the disclosure, the at least one processor 1930 of FIG. 19 and the at least one processor 2030 of FIG. 20 may not only control a series of processes such that respective devices operate, but may also control a series of processes such that mutual devices operate. For example, the at least one processor 1930 of FIG. 19 may be a configuration for controlling a series of processes such that the audio output device 2000 operates according to the embodiments of the disclosure described above with reference to FIGS. 1 to 18. As another example, the at least one processor 2030 of FIG. 20 may be a configuration for controlling a series of processes such that the audio processing device 1900 operates according to the embodiments of the disclosure described above with reference to FIGS. 1 to 18.

The at least one memory 2010 may store one or more instructions for outputting audio. The at least one processor 2030 may obtain a second audio signal according to the instruction stored in the at least one memory 2010, and may analyze a combination of preset signals included in the second audio signal so as to determine a channel layout for playing back audio. The at least one processor 2030 may play back audio via the channel layout determined according to the instruction stored in the at least one memory 2010. The at least one processor 2030 may restore audio by filtering the second audio signal, and may play back the restored audio via the determined channel layout, according to the instruction stored in the at least one memory 2010.

The at least one processor 2030 may perform at least some of the functions of the audio output device 300, 600, or 900 of FIG. 1, 8, or 12.

The devices for processing and outputting a multi-channel audio signal are separately described with reference to FIGS. 19 and 20, but, in an embodiment of the disclosure, a portion or all of the operations of processing and outputting a multi-channel audio signal may be performed by the audio processing device of FIG. 19 or may be performed by the audio output device of FIG. 20.

According to an embodiment of the disclosure, the electronic device may include at least one memory configured to store one or more instructions, and at least one processor. The at least one processor may be configured to execute a program or the one or more instructions stored in the memory to cause the electronic device to obtain playback layout information related to audio playback using a plurality of channels. The electronic device may obtain a first audio signal about audio to be played back via an LFE channel among the plurality of channels. The electronic device may obtain a second audio signal different from the first audio signal by transforming the first audio signal, based on the playback layout information. The electronic device may transmit the second audio signal to an external device.

In an embodiment of the disclosure, the at least one processor may be configured to execute the program or the one or more instructions stored in the memory to cause the electronic device to obtain the second audio signal by adding one or more preset signals to the first audio signal.

In an embodiment of the disclosure, the LFE channel may be a channel for outputting a low frequency effect sound. The one or more preset signals may each be a signal having a frequency band higher than the first audio signal.

In an embodiment of the disclosure, the at least one processor may be configured to execute the program or the one or more instructions stored in the memory to cause the electronic device to obtain the second audio signal by adding at least one of a first preset signal, a second preset signal, or a third preset signal to the first audio signal, based on the playback layout information.

In an embodiment of the disclosure, the second audio signal may be a signal obtained by adding, to the first audio signal, a combination of the one or more preset signals corresponding to the playback layout information.

In an embodiment of the disclosure, the at least one processor may be configured to execute the program or the one or more instructions stored in the memory to cause the electronic device to reduce an amplitude of the first audio signal, based on an amplitude of the one or more preset signals. The at least one processor may be configured to execute the program or the one or more instructions stored in the memory to cause the electronic device to obtain the second audio signal by adding the one or more preset signals to the first audio signal of which amplitude is reduced.

In an embodiment of the disclosure, a channel layout included in the playback layout information may correspond to a combination of 8 channels, and may include a 5.1.2 channel layout and a 7.1.0 channel layout.

The electronic device according to an embodiment of the disclosure may include memory configured to store one or more instructions, and at least one processor. The at least one processor may be configured to execute a program or the one or more instructions stored in the memory to cause the electronic device to receive an LFE channel audio signal about audio to be played back via an LFE channel among a plurality of channels. The electronic device may determine a channel layout for playing back the audio, based on a signal obtained by applying the LFE channel audio signal to one or more band-pass filters. The electronic device may output audio according to a signal obtained by applying the LFE channel audio signal to a low-pass filter.

In an embodiment of the disclosure, the at least one processor may be configured to execute the program or the one or more instructions stored in the memory to cause the electronic device to determine the channel layout by obtaining a combination of one or more preset signals by applying the LFE channel audio signal to the one or more band-pass filters. The electronic device may determine the channel layout based on the combination of one or more preset signals.

In an embodiment of the disclosure, the at least one processor may be configured to execute the program or the one or more instructions stored in the memory to cause the electronic device to generate an LFE output signal by amplifying an amplitude of the LFE channel audio signal, based on an amplitude of the one or more preset signals. The electronic device may output audio according to the generated LFE output signal.

In an embodiment of the disclosure, the LFE channel audio signal may include the combination of the first audio signal about audio to be played back via the LFE channel among the plurality of channels and one or more preset signals.

According to an embodiment of the disclosure, a method, performed by the electronic device, of processing an audio signal may include obtaining playback layout information related to audio playback using a plurality of channels. The method may include obtaining a first audio signal about audio to be played back via an LFE channel among the plurality of channels. The method may include obtaining a second audio signal different from the first audio signal by transforming the first audio signal, based on the playback layout information. The method may include transmitting the second audio signal from the electronic device to an external device.

In an embodiment of the disclosure, the obtaining of the second audio signal may include obtaining the second audio signal by adding one or more preset signals to the first audio signal.

In an embodiment of the disclosure, the LFE channel may be a channel for outputting a low frequency effect sound. The one or more preset signals may each be a signal having a frequency band higher than the first audio signal.

In an embodiment of the disclosure, the obtaining of the second audio signal may include obtaining the second audio signal by adding at least one of a first preset signal, a second preset signal, or a third preset signal to the first audio signal, based on the playback layout information.

In an embodiment of the disclosure, the obtaining of the second audio signal may include reducing an amplitude of the first audio signal, based on an amplitude of the one or more preset signals. The obtaining of the second audio signal may include obtaining the second audio signal by adding the one or more preset signals to the first audio signal of which amplitude is reduced.

According to an embodiment of the disclosure, a method, performed by the electronic device, of outputting an audio signal may include receiving an LFE channel audio signal about audio to be played back via an LFE channel among a plurality of channels. The method may include determining a channel layout for playing back the audio, based on a signal obtained by applying the LFE channel audio signal to one or more band-pass filters. The method may include outputting audio according to a signal obtained by applying the LFE channel audio signal to a low-pass filter.

In an embodiment of the disclosure, the determining of the channel layout may include obtaining the combination of one or more preset signals by applying the LFE channel audio signal to the one or more band-pass filters. The determining of the channel layout may include determining a channel layout based on the combination of one or more preset signals.

The LFE channel audio signal may include and the combination of the first audio signal about audio to be played back via the LFE channel among the plurality of channels one or more preset signals.

According to an embodiment of the disclosure, a non-transitory computer-readable recording medium may have recorded thereon a program for performing any one method of the disclosure, on a computer.

The electronic device according to an embodiment of the disclosure may include memory configured to store one or more instructions and at least one processor. The at least one processor may be configured to execute a program or the one or more instructions stored in the memory to cause the electronic device to receive an LFE channel audio signal about audio to be played back via an LFE channel among a plurality of channels. The electronic device may determine a channel layout for playing back the audio, based on a signal obtained by applying the LFE channel audio signal to a band-pass filter. The electronic device may output audio according to a signal obtained by applying the LFE channel audio signal to the low-pass filter.

Various embodiments of the disclosure may be implemented or supported by one or more computer programs, and the computer programs may be formed from computer-readable program code and may be included in a computer-readable medium. In the disclosure, the terms “application” and “program” may refer to one or more computer programs, software components, instruction sets, procedures, functions, objects, classes, instances, related data, or a portion thereof appropriate for implementation in computer-readable program code. The “computer readable program code” may include various types of computer code including source code, object code, and executable code. The “computer-readable medium” may include various types of media accessible by a computer, such as read only memories (ROMs), random access memories (RAMs), hard disk drives (HDDs), compact discs (CDs), digital video discs (DVDs), or various types of memories.

Also, the machine-readable storage medium may be provided in the form of a non-transitory storage medium. Here, the “non-transitory storage medium” may be a tangible device and may exclude wired, wireless, optical, or other communication links for transmitting temporary electrical or other signals. Moreover, the “non-transitory storage medium” may not distinguish between a case where data is semi-permanently stored in the storage medium and a case where data is temporarily stored therein. For example, the “non-transitory storage medium” may include a buffer in which data is temporarily stored. The computer-readable medium may be any available medium accessible by a computer, and may include volatile or non-volatile media and removable or non-removable media. The computer-readable medium may include a medium in which data may be permanently stored and a medium in which data may be stored and may be overwritten at a later time, such as a rewritable optical disk or an erasable memory device.

According to an embodiment of the disclosure, the method according to various embodiments of the disclosure described in the present specification may be included and provided in a computer program product. The computer program product may be traded as a product between a seller and a buyer. The computer program product may be distributed in the form of a machine-readable storage medium (e.g., a compact disc read only memory (CD-ROM)) or may be distributed (e.g., downloaded or uploaded) online via an application store or directly between two user devices. In the case of online distribution, at least a portion of the computer program product (e.g., a downloadable app) may be at least temporarily stored or temporarily generated in a machine-readable storage medium such as a manufacturer's server, a server of an application store, or memory of a relay server.

The aforementioned descriptions of the disclosure are merely examples, and one of ordinary skill in the art may easily understand that various modifications may be made therein without departing from the spirit or features of the disclosure. For example, appropriate results may be achieved even when the described technologies are performed in a different order from the described method and/or the elements of the described system, structure, apparatus, or circuit are coupled or combined in a different form from the described method or are replaced or substituted by other elements or equivalents thereof. Therefore, it is to be understood that the embodiments described above should be considered in a descriptive sense only and not for purposes of limitation. For example, configuring elements that are singular forms may be executed in a distributed fashion, and also, configuring elements that are distributed may be combined and then executed.

The scope of the disclosure is defined not by the above detailed description but by the following claims and their equivalents, and all modifications derived from the meaning and scope of the claims and equivalent concepts thereof should be construed as being included in the scope of the disclosure.

What is claimed is:

1. An electronic device comprising:
at least one memory configured to store one or more instructions; and
at least one processor configured to execute the one or more instructions to:
obtain playback layout information related to a playback of an audio using a plurality of channels;
obtain a first audio signal related to an audio to be played back via a low frequency effect (LFE) channel among the plurality of channels;
obtain a second audio signal different from the first audio signal, by transforming the first audio signal based on the playback layout information; and
transmit the second audio signal to an external device.

2. The electronic device of claim 1, wherein the at least one processor is configured to execute the one or more instructions to obtain the second audio signal by adding one or more preset signals to the first audio signal.

3. The electronic device of claim 2, wherein the LFE channel is a channel for outputting a low frequency effect sound, and
wherein the one or more preset signals is each a signal having a frequency band higher than the first audio signal.

4. The electronic device of claim 2, wherein the at least one processor is configured to execute the one or more instructions to obtain the second audio signal by adding at least one of a first preset signal, a second preset signal, or a third preset signal to the first audio signal, based on the playback layout information.

5. The electronic device of claim 2, wherein the second audio signal is a signal obtained by adding, to the first audio signal, a combination of the one or more preset signals corresponding to the playback layout information.

6. The electronic device of claim 2, wherein the at least one processor is configured to execute the one or more instructions to:
reduce an amplitude of the first audio signal, based on an amplitude of the one or more preset signals; and
obtain the second audio signal by adding the one or more preset signals to the first audio signal of which amplitude is reduced.

7. The electronic device of claim 1, wherein the playback layout information includes information about a channel layout, the channel layout corresponding to a combination of 8 channels, and including a 5.1.2 channel layout and a 7.1.0 channel layout.

8. A method, performed by an electronic device, of processing an audio signal, the method comprising:
obtaining playback layout information related to a playback of an audio using a plurality of channels;
obtaining a first audio signal related to an audio to be played back via a low frequency effect (LFE) channel among the plurality of channels;
obtaining a second audio signal different from the first audio signal, by transforming the first audio signal based on the playback layout information; and
transmitting the second audio signal from the electronic device to an external device.

9. The method of claim 8, wherein the obtaining the second audio signal comprises obtaining the second audio signal by adding one or more preset signals to the first audio signal.

10. The method of claim 9, wherein the LFE channel is a channel for outputting a low frequency effect sound, and
wherein each of the one or more preset signals is a signal having a frequency band higher than the first audio signal.

11. The method of claim 9, wherein the obtaining the second audio signal comprises obtaining the second audio signal by adding at least one of a first preset signal, a second preset signal, or a third preset signal to the first audio signal, based on the playback layout information.

12. The method of claim 9, wherein the obtaining the second audio signal comprises:
reducing an amplitude of the first audio signal, based on an amplitude of the one or more preset signals; and
obtaining the second audio signal by adding the one or more preset signals to the first audio signal of which amplitude is reduced.

13. A non-transitory computer-readable recording medium having recorded thereon a program executable by at least one processor to perform the method of claim 8.
